(19) United States
(12) Patent Application Publication
(10) Pub. No.: US 2026/0015458 A1
(43) Pub. Date: Jan. 15, 2026

(54) POLYCARBONATE RESIN COMPOSITION

(71) Applicant: MITSUBISHI CHEMICAL CORPORATION, Tokyo (JP)

(72) Inventors: Yukinori KOMIYA, Tokyo (JP); Hiroki ASABA, Tokyo (JP); Masashi YOKOGI, Tokyo (JP)

(73) Assignee: MITSUBISHI CHEMICAL CORPORATION, Tokyo (JP)

(21) Appl. No.: 19/336,606

(22) Filed: Sep. 23, 2025

Related U.S. Application Data
(63) Continuation of application No. PCT/JP2024/013073, filed on Mar. 29, 2024.

(30) Foreign Application Priority Data
Mar. 30, 2023 (JP) 2023-054760

(51) Int. Cl. C08G 64/18; C08G 64/30

(52) U.S. Cl. CPC C08G 64/183; C08G 64/307

(57) ABSTRACT

A polycarbonate resin composition having at least one glass transition temperature of 50° C. or lower and a bond between polymer chains by a Diels-Alder reaction. The polycarbonate resin composition preferably has at least one glass transition temperature of lower than 25° C. The bond between polymer chains of the polycarbonate resin composition is preferably formed by a reaction between a polycarbonate resin composition (I) having two or more conjugated diene structures and a compound (II) having two or more dienophile groups.

### CROSS-REFERENCE TO RELATED APPLICATIONS

The present application is a continuation of International Patent Application PCT/JP2024/013073, filed Mar. 29, 2024, which is based on and claims the benefit of priority to Japanese Patent Application No. 2023-054760 filed on Mar. 30, 2023. The entire contents of these applications are incorporated herein by reference.

### TECHNICAL FIELD

The present invention relates to a polycarbonate resin composition. More particularly, the present invention relates to a polycarbonate resin composition excellent in self-healing property, mechanical strength, and solvent resistance.

### BACKGROUND ART

Polycarbonate resins are excellent in mechanical strength, electrical properties, transparency, and the like, and are widely used as engineering plastics in various fields such as the field of electrical and electronic devices and the field of automobiles. In recent years, in these application fields, there has been progress in thinning, downsizing, and weight reduction of molded products, and further improvement in performance of molding materials has been required.

Polycarbonate resins using bisphenol A as a raw material in the related art do not have sufficiently excellent surface hardness to meet these requirements, are more easily scratched than glass, and appearance is impaired when formed into products. Accordingly, development of a polycarbonate resin having high surface hardness is desired (for example, see Patent Document 1).

However, even a polycarbonate resin having increased surface hardness is not completely free from scratches, and it is likely that scratches gradually accumulate and the appearance is impaired when used over time.

Thus, in recent years, attention has been paid to a material which is not made less susceptible to scratches but allows spontaneous recovery of the scratches, that is, a so-called self-healing polymer. In the self-healing polymer, even when a scratch is generated, the scratch is lost with passage of time, and thus, aesthetic appearance is maintained for a long period of time (for example, see Patent Document 2).

On the other hand, Patent Document 3 discloses an aromatic polycarbonate and a polyarylate resin having a bond between polymer chains by a Diels-Alder reaction and being excellent in abrasion resistance as an electrophotographic photoreceptor.

### CITATION LIST

### Patent Document

Patent Document 1: JP S64-69625 A
Patent Document 2: WO 2007/069765
Patent Document 3: WO 2021/201228

### SUMMARY OF INVENTION

### Technical Problem

The polycarbonate resin of Patent Document 3 has a bond between polymer chains by the Diels-Alder reaction. However, it uses an aromatic diol as a monomer, and thus has a glass transition temperature higher than room temperature, and does not have a self-healing property in which a scratch is restored to the original state.

The object of the present invention is to provide a polycarbonate resin composition excellent in self-healing property, mechanical strength, and solvent resistance.

### Solution to Problem

The present inventors have found that a polycarbonate resin composition having a specific glass transition temperature and having a bond formed by a specific reaction between polymer chains can be a polycarbonate resin composition that meets the above object.

The gist of the present invention is present in the following [1] to [19].

[1] A polycarbonate resin composition having:
at least one glass transition temperature of 50° C. or lower; and
a bond between polymer chains by a Diels-Alder reaction.

[2] The polycarbonate resin composition according to [1], having at least one glass transition temperature of lower than 25° C.

[3] The polycarbonate resin composition according to [1] or [2], wherein the bond between the polymer chains of the polycarbonate resin composition is formed by a reaction between a polycarbonate resin composition (I) having two or more conjugated diene structures and a compound (II) having two or more dienophile groups.

[4] The polycarbonate resin composition according to [1] or [2], wherein the bond between the polymer chains of the polycarbonate resin composition is formed by a reaction between a polycarbonate resin composition (III) having two or more dienophile structures and a compound (IV) having two or more conjugated diene groups.

[5] The polycarbonate resin composition according to [1] or [2], wherein the bond between the polymer chains of the polycarbonate resin composition is formed by a reaction between the polycarbonate resin composition (I) having two or more conjugated diene structures and the polycarbonate resin composition (III) having two or more dienophile structures.

[6] The polycarbonate resin composition according to [3] or [5], wherein the polycarbonate resin composition (I) having two or more conjugated diene structures has a conjugated diene structure represented by any one of the group consisting of Formulae (2), (3), and (4).

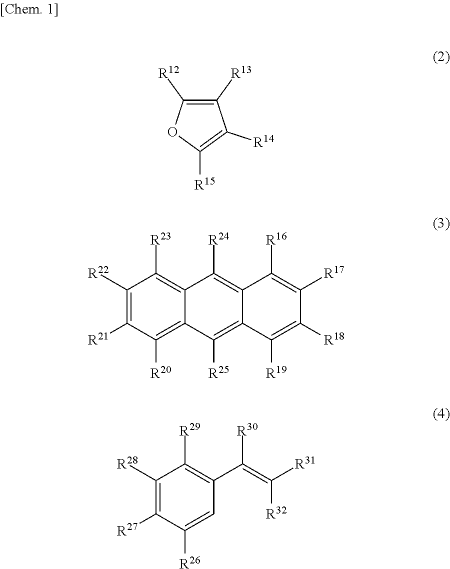

In Formula (2), R¹² to R¹⁵ each independently represent a single bond, a bonding group to another skeleton, a hydrogen atom, an aliphatic hydrocarbon group having 1 to 12 carbon atoms, an aromatic hydrocarbon group having 6 to 12 carbon atoms, or an alkoxy group having 1 to 10 carbon atoms. One or two of R¹² to R¹⁵ are a single bond or a bonding group to another skeleton.

In Formula (3), R¹⁶ to R²⁵ each independently represent a single bond, a bonding group to another skeleton, a hydrogen atom, an aliphatic hydrocarbon group having 1 to 12 carbon atoms, an aromatic hydrocarbon group having 6 to 12 carbon atoms, or an alkoxy group having 1 to 10 carbon atoms. One or two of R¹⁶ to R²⁵ are a single bond or a bonding group to another skeleton.

In Formula (4), R²⁶ to R³² each independently represent a single bond, a bonding group to another skeleton, a hydrogen atom, an aliphatic hydrocarbon group having 1 to 12 carbon atoms, an aromatic hydrocarbon group having 6 to 12 carbon atoms, or an alkoxy group having 1 to 10 carbon atoms. One or two of R²⁶ to R³² are a single bond or a bonding group to another skeleton.

[7] The polycarbonate resin composition according to [1], [5], or [6], wherein the polycarbonate resin composition (I) having two or more conjugated diene structures contains a carbonate structural unit (A) derived from a dihydroxy compound having a conjugated diene structure represented by Formula (A-1).

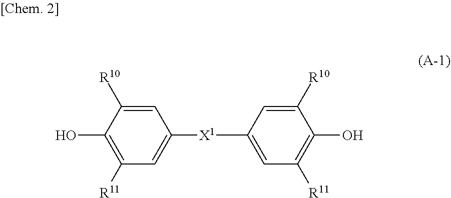

In Formula (A-1), R¹⁰ and R¹¹ each independently represent a hydrogen atom, an alkyl group, or an aryl group. X¹ represents a divalent linking group including a conjugated diene structure.

[8] The polycarbonate resin composition according to [7], wherein the dihydroxy compound having the conjugated diene structure represented by Formula (A-1) contains at least one or more dihydroxy compounds represented by any one of the group consisting of Formulae (A-2), (A-3), and (A-4).

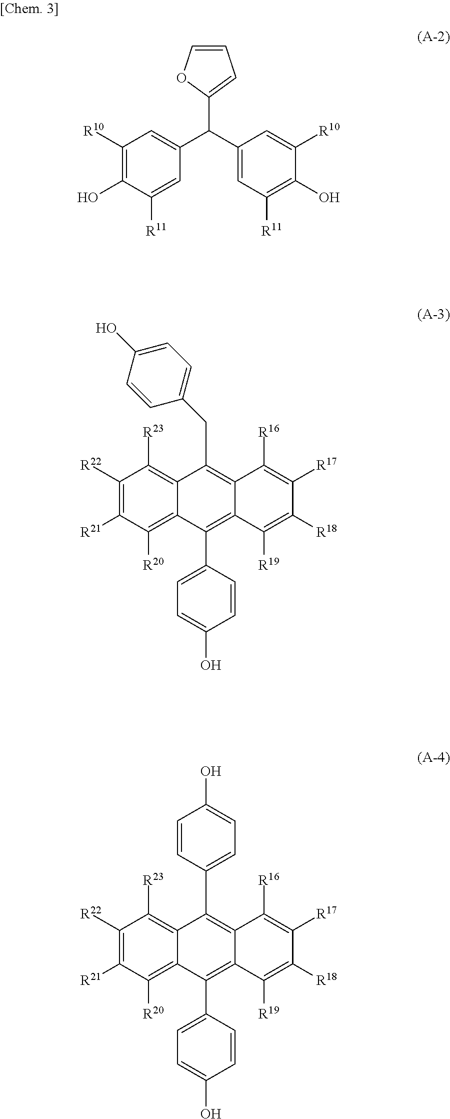

In Formula (A-2), R¹⁰ and R¹¹ each independently represent a hydrogen 5 atom, an alkyl group, or an aryl group.

In Formulae (A-3) and (A-4), R¹⁶ to R²³ each independently represent a hydrogen atom, an aliphatic hydrocarbon group having 1 to 12 carbon atoms, an aromatic hydrocarbon group having 6 to 12 carbon atoms, or an alkoxy group having 1 to 10 carbon atoms.

[9] The polycarbonate resin composition according to [8], wherein the dihydroxy compounds represented by Formulae (A-2), (A-3), and (A-4) are dihydroxy compounds represented by Formulae (A-5), (A-6), and (A-7), respectively.

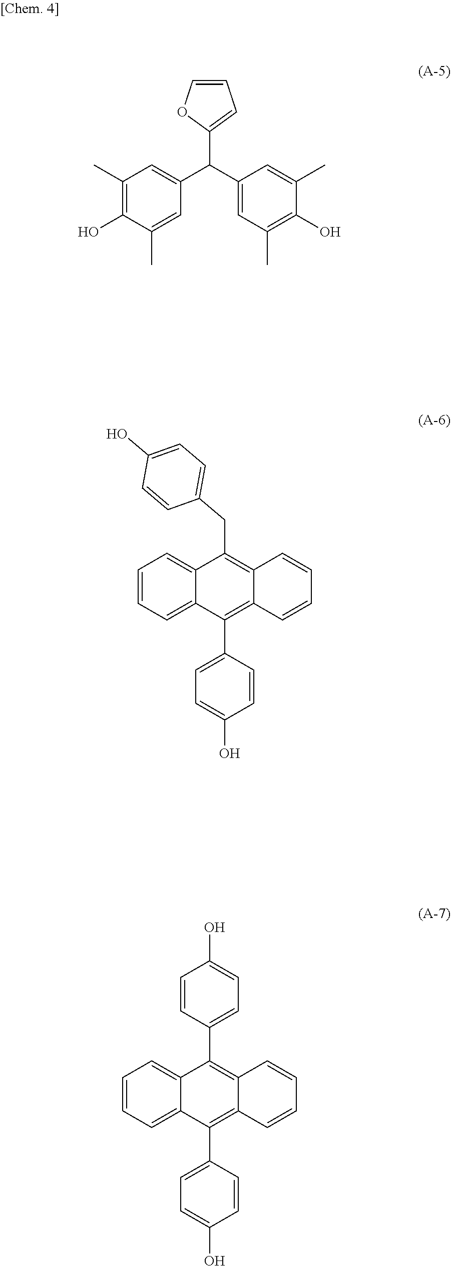 [SMILES: Cc1cc(C(c2cc(C)c(O)c(C)c2)c2ccco2)cc(C)c1O ; Oc1ccc(Cc2c3ccccc3c(-c3ccc(O)cc3)c3ccccc23)cc1 ; Oc1ccc(-c2c3ccccc3c(-c3ccc(O)cc3)c3ccccc23)cc1]

[10] The polycarbonate resin composition according to [4], wherein the compound (IV) having two or more conjugated diene groups has a structure represented by any one of the group consisting of Formulae (2), (3) and (4).

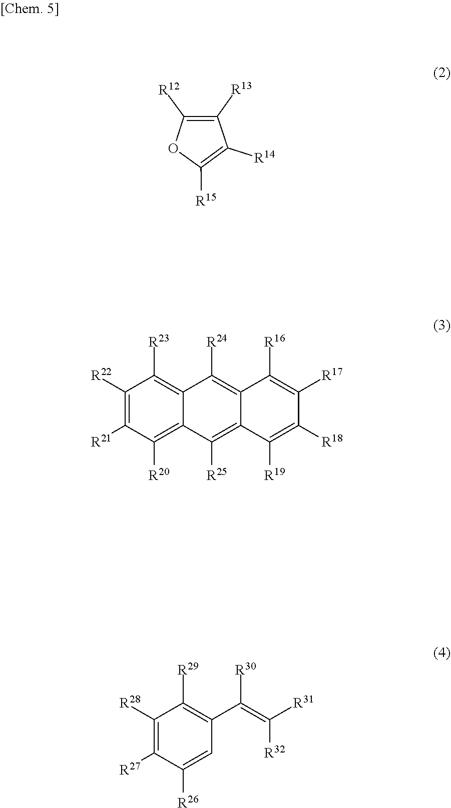

In Formula (2), R¹² to R¹⁵ each independently represent a single bond, a bonding group to another skeleton, a hydrogen atom, an aliphatic hydrocarbon group having 1 to 12 carbon atoms, an aromatic hydrocarbon group having 6 to 12 carbon atoms, or an alkoxy group having 1 to 10 carbon atoms. One or two of R¹² to R¹⁵ are a single bond or a bonding group to another skeleton.

In Formula (3), R¹⁶ to R²⁵ each independently represent a single bond, a bonding group to another skeleton, a hydrogen atom, an aliphatic hydrocarbon group having 1 to 12 carbon atoms, an aromatic hydrocarbon group having 6 to 12 carbon atoms, or an alkoxy group having 1 to 10 carbon atoms. One or two of R¹⁶ to R²⁵ are a single bond or a bonding group to another skeleton.

In Formula (4), R²⁶ to R³² each independently represent a single bond, a bonding group to another skeleton, a hydrogen atom, an aliphatic hydrocarbon group having 1 to 12 carbon atoms, an aromatic hydrocarbon group having 6 to 12 carbon atoms, or an alkoxy group having 1 to 10 carbon atoms. One or two of R²⁶ to R³² are a single bond or a bonding group to another skeleton.

[11] The polycarbonate resin composition according to [1] or any one of [5] to [9], wherein the polycarbonate resin composition (I) has a viscosity average molecular weight of 10000 to 50000.

[12] The polycarbonate resin composition according to [3], wherein the compound (II) having two or more dienophile groups has a dienophile group having a structure represented by Formula (5).

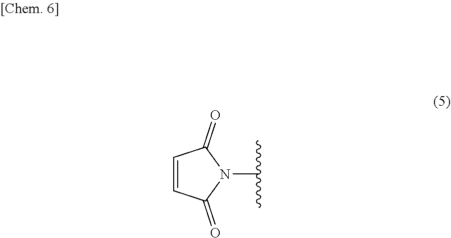 [SMILES: *N1C(=O)C=CC1=O]

[13] The polycarbonate resin composition according to [12], wherein the compound (II) having two or more dienophile groups is a compound represented by Formula (II-1).

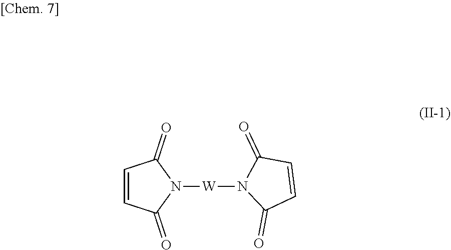

[14] In Formula (II-1), W represents a single bond or a divalent linking group including 1 to 30 carbon atoms, 0 to 2 oxygen atoms, and a hydrogen atom.

The polycarbonate resin composition according to [4] or [5], wherein the polycarbonate resin composition (III) having two or more dienophile structures has a dienophile structure represented by Formula (5).

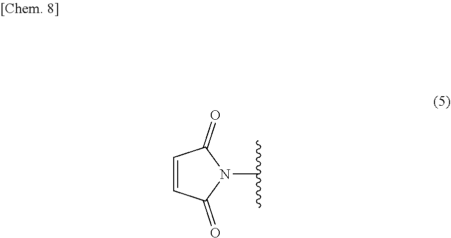 [SMILES: *N1C(=O)C=CC1=O]

[15] The polycarbonate resin composition according to any one of [1] to [14], including a carbonate structural unit (B) derived from an aliphatic dihydroxy compound represented by Formula (B-1).

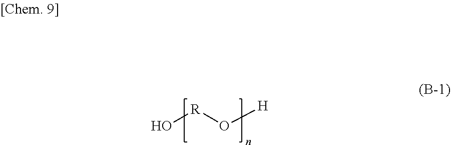

In Formula (B-1), R represents an alkylene group having 1 to 20 carbon atoms, and n is an integer of 1 to 100.

[16] The polycarbonate resin composition according to [15], wherein a content of the carbonate structural unit (B) per 100 mass % of the polycarbonate resin composition is 20 mass % or more and 99 mass % or less.

[17] The polycarbonate resin composition according to or [16], wherein the aliphatic dihydroxy compound represented by Formula (B-1) is an aliphatic dihydroxy compound represented by Formula (B-2).

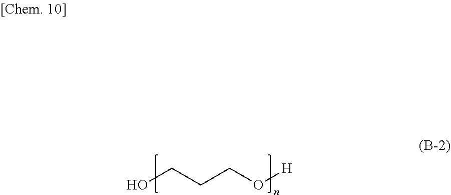

In Formula (B-2), n is an integer of 1 to 100.

[18] The polycarbonate resin composition according to [17], wherein the aliphatic dihydroxy compound represented by Formula (B-2) has a number average molecular weight of 200 or more and 3000 or less.

[19] The polycarbonate resin composition according to any one of [1] to [18], including a carbonate structural unit (C) derived from an aromatic dihydroxy compound represented by Formula (C-1).

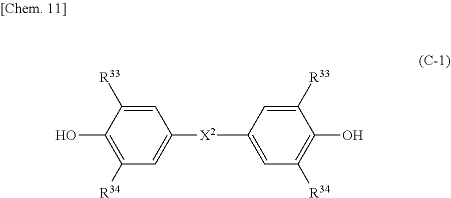

In Formula (C-1), R³³ and R³⁴ each independently represent a hydrogen atom, an alkyl group, or an aryl group.

X² represents —O—, —S—, —SO₂—, or —CR³⁵R³⁶—, with the proviso that R³⁵ and R³⁶ each independently represent a hydrogen atom, a substituted or unsubstituted alkyl group having 1 to 20 carbon atoms, or a substituted or unsubstituted aryl group, and the alkyl groups of R³⁵ and R³⁶ may be bonded to each other to form a ring. X² contains no conjugated diene structure.

### Advantageous Effects of Invention

According to the present invention, a polycarbonate resin composition excellent in self-healing property, mechanical strength, and solvent resistance can be provided.

The polycarbonate resin composition of the present invention has a good self-healing property and mechanical strength, and thus can be widely used as a material for producing parts in the fields of automobiles, electrical and electronic materials, and other industries.

### DESCRIPTION OF EMBODIMENTS

Hereinafter, the present invention will be described in detail with reference to embodiments and examples. The present invention is not limited to the embodiments and examples described below to be interpreted.

In the present specification, “to” is used to mean that numerical values described before and after “to” are included as a lower limit value and an upper limit value unless otherwise specified.

### [Polycarbonate Resin Composition]

A polycarbonate resin composition of the present invention has at least one glass transition temperature of 50° C. or lower and has a bond between polymer chains by a Diels-Alder reaction.

The polycarbonate resin composition of the present invention has at least one glass transition temperature of 50° C. or lower and has a bond between polymer chains by the Diels-Alder reaction, and thus, a reversible reaction of the Diels-Alder reaction can be performed at a low temperature, whereby the polycarbonate resin composition can have a good self-healing property and be excellent in mechanical strength. In addition, crosslinking by the Diels-Alder reaction can provide excellent solvent resistance.

### (Glass Transition Temperature)

The glass transition temperature of the polycarbonate resin composition of the present invention is determined by heating the composition at a temperature rising rate of 20° C./min and measuring a heat quantity using a differential scanning calorimeter in accordance with JIS K7121-1987. The polycarbonate resin composition of the present invention only needs to have at least one glass transition temperature of 50° C. or lower, and may have a plurality of glass transition temperatures of 50° C. or lower. The polycarbonate resin composition may have one or more glass transition temperatures in a temperature range of 50° C. or lower and one or more glass transition temperatures in a temperature range of higher than 50° C. The polycarbonate resin composition of the present invention has a glass transition temperature of 50° C. or lower, and thus can have a good self-healing property and mechanical strength.

In the polycarbonate resin composition of the present invention, the glass transition temperature of 50° C. or lower is preferably lower than 25° C., more preferably 10° C. or lower, and still more preferably 0° C. or lower.

The lower limit of the glass transition temperature of the polycarbonate resin composition of the present invention is not particularly limited, but is usually −100° C. or higher.

Examples of a method for producing a polycarbonate resin composition having such a glass transition temperature include the following methods.

(1) An aliphatic diol having no cyclic skeleton is copolymerized to lower the glass transition temperature (for example, a carbonate structural unit (B) is introduced).

(2) A plasticizer is added to lower the glass transition temperature.

### (Bond Between Polymer Chains by Diels-Alder Reaction)

The polycarbonate resin composition of the present invention has a bond between polymer chains by a Diels-Alder reaction.

The Diels-Alder reaction is a reaction in which a dienophile is added to a conjugated diene to form a six-membered ring structure.

The polycarbonate resin composition of the present invention has a six-membered ring structure between polymer chains, which is formed by a reaction between a polycarbonate resin composition having a conjugated diene structure and/or a dienophile structure and a polycarbonate resin composition or compound having a structure that causes the Diels-Alder reaction with the polycarbonate resin composition having a conjugated diene structure and/or a dienophile structure. For example, the polycarbonate resin composition of the present invention has a six-membered ring structure between polymer chains, which is formed by the Diels-Alder reaction between a conjugated diene of a furan skeleton, an anthracene skeleton, a styryl skeleton, or the like and a dienophile of a maleimide skeleton or the like. The presence of the bond between polymer chains by the Diels-Alder reaction can provide excellent mechanical strength and heat resistance. The presence or absence of the bond between polymer chains by the Diels-Alder reaction can be determined by a differential scanning calorimeter, NMR, or the like.

In the present invention, the polycarbonate resin composition is a concept encompassing any of a homopolymer, a copolymer, and a mixture of a plurality of polycarbonate resins. The homopolymer and the copolymer are sometimes simply referred to as “polycarbonate resins”, and these are also encompassed in the polycarbonate resin composition according to the present invention.

Although not particularly limited, examples of the bond between polymer chains by the Diels-Alder reaction in the polycarbonate resin composition of the present invention include the following embodiments.

(1) A bond formed by a reaction between a polycarbonate resin composition (I) having two or more conjugated diene structures, and a compound (II) having two or more dienophile groups (hereinafter, this embodiment is sometimes referred to as a “first embodiment”)

(2) A bond formed by a reaction between a polycarbonate resin composition (III) having two or more dienophile structures, and a compound (IV) having two or more conjugated diene groups (hereinafter, this embodiment is sometimes referred to as a “second embodiment”)

(3) A bond formed by a reaction between the polycarbonate resin composition (I) having two or more conjugated diene structures and the polycarbonate resin composition (III) having two or more dienophile structures (hereinafter, this embodiment is sometimes referred to as a “third embodiment”)

That is, the form of the polycarbonate resin composition of the present invention is not particularly limited as long as it has at least one glass transition temperature of 50° C. or lower and has the bond between polymer chains by the Diels-Alder reaction. Thus, the polycarbonate resin composition of the present invention may be any of a polycarbonate resin composition of the first embodiment in which the bond between polymer chains by the Diels-Alder reaction is formed by the reaction between the polycarbonate resin composition (I) having two or more conjugated diene structures and the compound (II) having two or more dienophile groups, a polycarbonate resin composition of the second embodiment in which the bond between polymer chains by the Diels-Alder reaction is formed by the reaction between the polycarbonate resin composition (III) having two or more dienophile structures and the compound (IV) having two or more conjugated diene groups, and a polycarbonate resin composition of the third embodiment in which the bond between polymer chains by the Diels-Alder reaction is formed by the reaction between the polycarbonate resin composition (I) having two or more conjugated diene structures and the polycarbonate resin composition (III) having two or more dienophile structures.

In addition, from the viewpoint of the self-healing property, a content of the carbonate structural unit (B) described below in the polycarbonate resin composition of the present invention is, as the lower limit, preferably 20 mass % or more, and more preferably 35 mass % or more. The upper limit thereof is preferably 99 mass % or less, and more preferably 80 mass % or less.

The polycarbonate resin composition of the present invention may contain an additional component as necessary as long as desired physical properties are not significantly impaired. Examples of the additional component include various resin additives, and resins other than the polycarbonate resin. As the various resin additives and the resins other than the polycarbonate resin, the same resin additives and resins as those that can be used in the polycarbonate resin composition (I) described below can be used.

The polycarbonate resin composition of the present invention preferably has a biomass degree of 10 mass % or more, and more preferably 25 mass % or more. Here, the biomass degree of the polycarbonate resin composition of the present invention is defined as a mass ratio of a carbonate structural unit synthesized from a plant-derived resource to carbonate structural units contained in the polycarbonate resin composition of the present invention.

Hereinafter, the polycarbonate resin composition of the present invention will be described for each embodiment.

### First Embodiment

The bond between polymer chains of the polycarbonate resin composition of the first embodiment is formed by the Diels-Alder reaction between the polycarbonate resin composition (I) having two or more conjugated diene structures and the compound (II) having two or more dienophile groups.

That is, the polycarbonate resin composition of the first embodiment is a composition containing a reaction product produced by subjecting the polycarbonate resin composition (I) having two or more conjugated diene structures and the compound (II) having two or more dienophile groups to the Diels-Alder reaction.

### <Polycarbonate Resin Composition (I) Having Two or More Conjugated Diene Structures>

The polycarbonate resin composition (I) having two or more conjugated diene structures (hereinafter, sometimes simply referred to as “polycarbonate resin composition (I)”) may contain two or more conjugated diene structures derived from a compound containing one conjugated diene, or may contain a conjugated diene structure derived from a compound containing two conjugated dienes. The polycarbonate resin composition (I) may be a homopolymer of a polycarbonate resin, a copolymer of a polycarbonate resin, or a mixture containing two or more types of polycarbonate resins, as long as it contains two or more conjugated diene structures.

### (Conjugated Diene Structure)

As the conjugated diene structure, any structure can be applied as long as it is a structure that causes the Diels-Alder reaction, but a structure having a furan skeleton, an anthracene skeleton, or a styryl skeleton is preferable, and a structure having a furan skeleton, which has a good self-healing property even at a low temperature, is particularly preferable.

Specifically, the polycarbonate resin composition (I) preferably has a conjugated diene structure represented by any one of Formulae (2), (3), and (4):

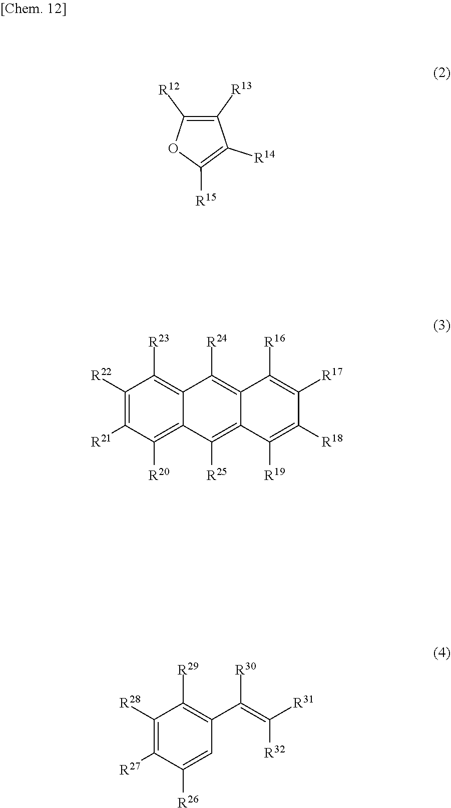

In Formula (2), R¹² to R¹⁵ each independently represent a single bond, a bonding group to another skeleton, a hydrogen atom, an aliphatic hydrocarbon group having 1 to 12 carbon atoms, an aromatic hydrocarbon group having 6 to 12 carbon atoms, or an alkoxy group having 1 to 10 carbon atoms. One or two of R¹² to R¹⁵ are a single bond or a bonding group to another skeleton.

In Formula (3), R¹⁶ to R²⁵ each independently represent a single bond, a bonding group to another skeleton, a hydrogen atom, an aliphatic hydrocarbon group having 1 to 12 carbon atoms, an aromatic hydrocarbon group having 6 to 12 carbon atoms, or an alkoxy group having 1 to 10 carbon atoms. One or two of R¹⁶ to R²⁵ are a single bond or a bonding group to another skeleton.

In Formula (4), R²⁶ to R³² each independently represent a single bond, a bonding group to another skeleton, a hydrogen atom, an aliphatic hydrocarbon group having 1 to 12 carbon atoms, an aromatic hydrocarbon group having 6 to 12 carbon atoms, or an alkoxy group having 1 to 10 carbon atoms. One or two of R²⁶ to R³² are a single bond or a bonding group to another skeleton.

### (Carbonate Structural Unit (A))

The polycarbonate resin composition (I) having two or more conjugated diene structures preferably contains a carbonate structural unit (A) derived from a dihydroxy compound having a conjugated diene structure represented by Formula (A-1) (hereinafter, sometimes simply referred to as “carbonate structural unit (A)”). The carbonate structural unit (A) is more preferably a carbonate structural unit derived from a dihydroxy compound containing, as X¹, a furan skeleton, an anthracene skeleton, or a styryl skeleton.

That is, the Diels-Alder reaction occurs between a furan skeleton, an anthracene skeleton, or a styryl skeleton and a dienophile group or a dienophile structure.

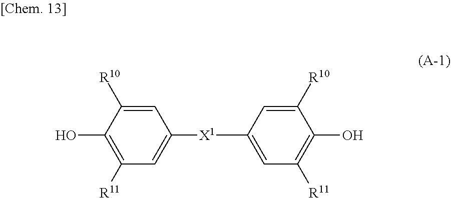

In Formula (A-1), R¹⁰ and R¹¹ each independently represent a hydrogen atom, an alkyl group, or an aryl group. X¹ represents a divalent linking group including a conjugated diene structure.

The alkyl groups represented by R¹⁰ and R¹¹ in Formula (A-1) each may be unsubstituted, or may have a substituent. Examples of the substituent which the alkyl group may have include a halogen atom, a nitro group, a cyano group, a hydroxy group, an aryl group, an alkoxy group, an aryloxy group, a carboxylic acid group, an alkoxycarbonyl group, an acyl group, and an acyloxy group. The alkyl groups represented by R¹⁰ and R¹¹ each may be linear, branched, or cyclic. The number of carbon atoms of each of the alkyl groups represented by R¹⁰ and R¹¹ is preferably 1 to 15, and more preferably 1 to 10.

In the present invention, the number of carbon atoms means the number of carbon atoms of the entire group. For example, in a case where the alkyl group is an alkyl group having a substituent, the number of carbon atoms of the alkyl group means the number of carbon atoms of the entire alkyl group including the number of carbon atoms of the substituent.

Specific examples of the alkyl groups represented by R¹⁰ and R¹¹ include a methyl group, an ethyl group, an n-propyl group, an n-butyl group, an n-pentyl group, an n-hexyl group, an n-heptyl group, an n-octyl group, an n-nonyl group, an n-decyl group, an n-undecyl group, an n-dodecyl group, an n-tridecyl group, an n-tetradecyl group, an n-pentadecyl group, a methylethyl group, a methylpropyl group, a methylbutyl group, a methylpentyl group, a methylhexyl group, a methylheptyl group, a methyloctyl group, a methylnonyl group, a methyldecyl group, a methylundecyl group, a methyldodecyl group, a methyltridecyl group, a methyltetradecyl group, a dimethylethyl group, a dimethylpropyl group, a dimethylbutyl group, a dimethylpentyl group, a dimethylhexyl group, a dimehylheptyl group, a dimethyloctyl group, a dimethylnonyl group, a dimethyldecyl group, a dimethylundecyl group, a dimethyldodecyl group, a dimethyltridecyl group, a trimethylpropyl group, a trimethylbutyl group, a trimethylpentyl group, a trimethylhexyl group, a trimethylheptyl group, a trimethyloctyl group, a trimethylnonyl group, a trimethyldecyl group, a trimethylundecyl group, a trimethyldodecyl group, an ethylbutyl group, an ethylpentyl group, an ethylhexyl group, an ethylheptyl group, an ethyloctyl group, an ethylnonyl group, an ethyldecyl group, an ethylundecyl group, an ethyldodecyl group, an ethyltridecyl group, a cyclohexyl group, a methylcyclohexyl group, a dimethylcyclohexyl group, a trimethylcyclohexyl group, a tetramethylcyclohexyl group, an ethylcyclohexyl group, a diethylcyclohexyl group, and a methylethylcyclohexyl group.

The aryl groups represented by R¹⁰ and R¹¹ each may be unsubstituted, or may have a substituent. Examples of the substituent which the aryl group may have include a halogen atom, a nitro group, a cyano group, a hydroxy group, an alkyl group, an alkoxy group, an aryloxy group, a carboxylic acid group, an alkoxycarbonyl group, an acyl group, and an acyloxy group. The number of carbon atoms of each of the aryl groups represented by R¹⁰ and R¹¹ is
preferably 6 to 15, and more preferably 6 to 10.

Specific examples of the aryl groups represented by R¹⁰ and R¹¹ include a naphthyl group, a phenyl group, and a tolyl group.

Among them, R¹⁰ and R¹¹ are each independently preferably a hydrogen atom or an alkyl group.

Examples of the divalent linking group containing a conjugated diene structure represented by X¹ include a divalent linking group containing a furan skeleton, a divalent linking group containing an anthracene skeleton, and a divalent linking group containing a styryl skeleton. The number of carbon atoms of the divalent linking group containing a conjugated diene structure represented by X¹ is preferably about 4 to 25. Examples of X¹ include a divalent linking group having a furan skeleton having 4 to 15 carbon atoms, a divalent linking group having an anthracene skeleton having 14 to 25 carbon atoms, and a divalent linking group having a styryl skeleton having 9 to 20 carbon atoms.

Examples of such a divalent linking group include a furylalkanediyl group (a divalent group in which one hydrogen atom of an alkane is substituted with a furyl group and two hydrogen atoms of the alkane are removed), a furandiyl group (a divalent group in which two hydrogen atoms are removed from furan), an anthrylalkanediyl group (a divalent group in which one hydrogen atom of an alkane is substituted with an anthryl group and two hydrogen atoms of the alkane are removed), an anthracenediyl group (a divalent group in which two hydrogen atoms are removed from anthracene), a styrylalkanediyl group (a divalent group in which one hydrogen atom of an alkane is substituted with a styryl group and two hydrogen atoms of the alkane are removed), a vinylarylalkanediyl group (a divalent group in which one hydrogen atom of an alkane is substituted with a vinylaryl group and two hydrogen atoms of the alkane are removed), and a vinylarylene group (a divalent group in which two hydrogen atoms are removed from vinylbenzene).

These divalent linking groups each may be unsubstituted or may have a substituent. As these divalent linking groups, a furylalkanediyl group having 5 to 15 carbon atoms, a furandiyl group having 4 to 15 carbon atoms, an anthrylalkanediyl group having 15 to 25 carbon atoms, an anthracenediyl group having 14 to 25 carbon atoms, a styrylalkanediyl group having 9 to 20 carbon atoms, a vinylarylalkanediyl group having 9 to 20 carbon atoms, or a vinylarylene group having 8 to 20 carbon atoms is preferable. The substituent which these linking groups may have is the same as the substituent which the alkyl group or the aryl group may have.

Specific examples of X¹ include a furylmethylene group, an anthracene 9,10-diyl group, a styrylmethylene group, and a vinylphenylene group.

Specific examples of the dihydroxy compound represented by Formula (A-1) include dihydroxy compounds represented by any one of Formulae (A-2), (A-3), and (A-4).

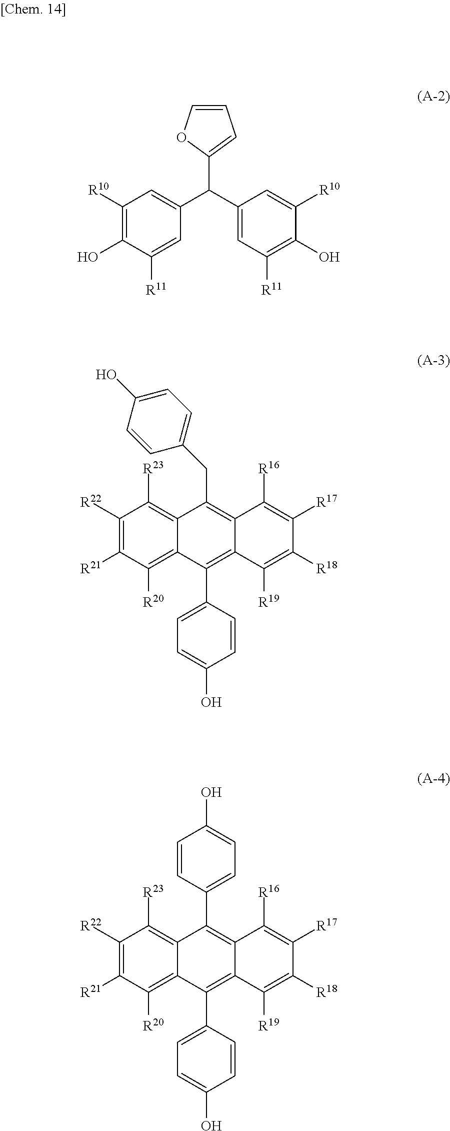

In Formula (A-2), R¹⁰ and R¹¹ each independently represent a hydrogen 5 atom, an alkyl group, or an aryl group.

In Formulae (A-3) and (A-4), R¹⁶ to R²³ each independently represent a hydrogen atom, an aliphatic hydrocarbon group having 1 to 12 carbon atoms, an aromatic hydrocarbon group having 6 to 12 carbon atoms, or an alkoxy group having 1 to 10 carbon atoms.

R¹⁰ and R¹¹ in Formula (A-2) are synonymous with R¹⁰ and R¹¹ in Formula (A-1).

Examples of the aliphatic hydrocarbon group and the aromatic hydrocarbon group of R¹⁶ to R²³ in Formulae (A-3) and (A-4) include the alkyl group and the aryl group exemplified as R¹⁰ and R¹¹ in Formula (A-2), respectively. Examples of the alkoxy group include a methoxy group and an ethoxy group.

The dihydroxy compounds represented by Formulae (A-2), (A-3), and (A-4) are preferably dihydroxy compounds represented by Formulae (A-5), (A-6), and (A-7), respectively.

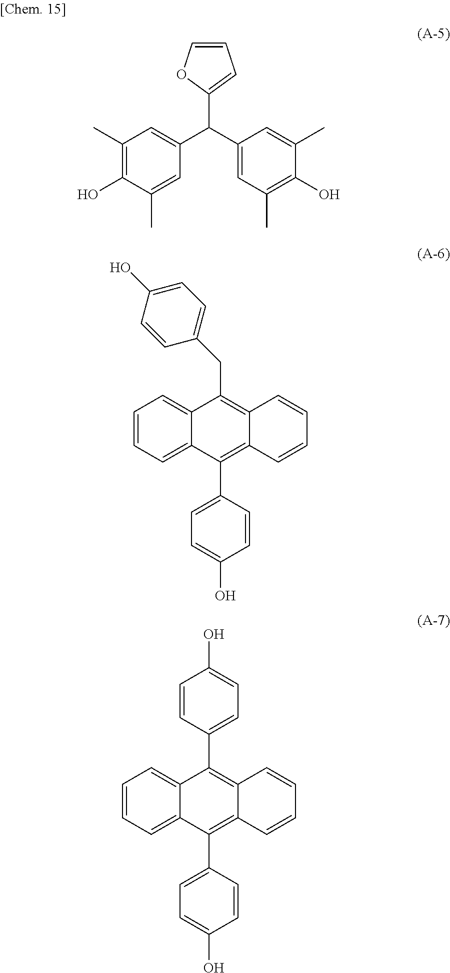

### Carbonate Structural Unit (B)

To have at least one glass transition temperature of 50° C. or lower, the polycarbonate resin composition (I) preferably contains two or more conjugated diene structures and a carbonate structural unit derived from an aliphatic dihydroxy compound, and more preferably contains two or more conjugated diene structures and a carbonate structural unit (B) derived from an aliphatic dihydroxy compound represented by Formula (B-1) (hereinafter, sometimes simply referred to as “carbonate structural unit (B)”).

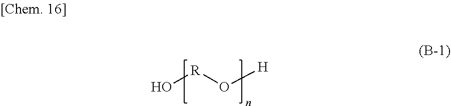

In Formula (B-1), R represents an alkylene group having 1 to 20 carbon atoms, and n is an integer of 1 to 100.

The alkylene group represented by R in Formula (B-1) may be unsubstituted or may have a substituent, and may be linear, branched, or cyclic. The substituent which the alkylene group may have is the same as the substituent which the alkyl group may have. R is preferably an alkylene group having 2 to 5 carbon atoms.

R is preferably represented by “—(CH₂)ₘ—”. Here, m is an integer of 1 to 20, and preferably 2 to 5.

In addition, n in Formula (B-1) represents an average number of repetitions and is an integer of 1 to 100.

The aliphatic dihydroxy compound represented by Formula (B-1) is preferably an aliphatic dihydroxy compound represented by Formula (B-2), that is, polytrimethylene ether glycol (PO3G) from the viewpoint of polymerizability.

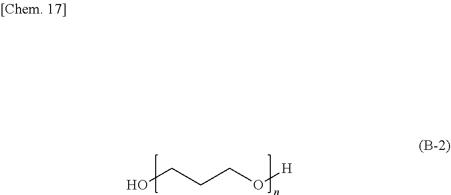

In Formula (B-2), n is an integer of 1 to 100.

The PO3G used as a raw material for the carbonate structural unit (B) is preferably PO3G having a biomass degree of 100%, which is synthesized by condensing 1,3-propanediol produced from a plant-derived raw material. Note that whether or not PO3G or the like is produced from a plant-derived resource can be confirmed by, for example, measuring the concentration of radioactive carbon (¹⁴C).

The number average molecular weight of PO3G is preferably 200 or more and 3000 or less. The lower limit of the number average molecular weight of PO3G is more preferably 240 or more, and particularly preferably 420 or more. The upper limit of the number average molecular weight of PO3G is more preferably 2850 or less, and particularly preferably 2800 or less. Accordingly, n in Formula (B-2) is preferably a number satisfying this number average molecular weight.

When the polycarbonate resin composition (I) contains the carbonate structural unit (B) derived from PO3G, the glass transition temperature of the polycarbonate resin composition (I) is lowered and a good self-healing property is imparted. When the number average molecular weight of PO3G is the lower limit or more, the glass transition temperature can be lowered with a small amount. When the number average molecular weight of PO3G is the above upper limit or less, compatibility with another copolymerization component is good, and it is possible to prevent a problem such as deterioration of clarity due to poor compatibility or failure of polymerization.

### (Other Carbonate Structural Unit)

The polycarbonate resin composition (I) may contain a carbonate structural unit other than the dihydroxy compound having a conjugated diene structure and the aliphatic dihydroxy compound represented by Formula (B-1), that is, a carbonate structural unit derived from an aromatic and/or aliphatic dihydroxy compound other than the dihydroxy compound having a conjugated diene structure and the aliphatic dihydroxy compound represented by Formula (B-1), within a range that does not impair the object of the present invention.

Examples of the other carbonate structural unit include a carbonate structural unit (C) derived from an aromatic dihydroxy compound represented by Formula (C-1) (hereinafter, sometimes simply referred to as “carbonate structural unit (C)”).

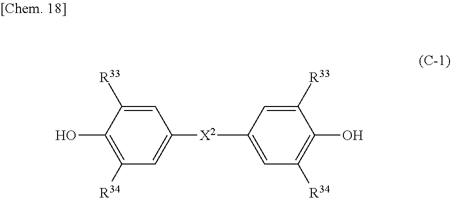

In Formula (C-1), R³³ and R³⁴ each independently represent a hydrogen atom, an alkyl group, or an aryl group.

X² represents —O—, —S—, —SO₂—, or —CR³⁵R³⁶—, with the proviso that R³⁵ and R³⁶ each independently represent a hydrogen atom, a substituted or unsubstituted alkyl group having 1 to 20 carbon atoms, or a substituted or unsubstituted aryl group, and the alkyl groups of R³⁵ and R³⁶ may be bonded to each other to form a ring. X² does not contain a conjugated diene structure.

The alkyl group represented by R³³ and R³⁴ may be unsubstituted or may have a substituent. The substituent which the alkyl group may have is the same as the substituent which the alkyl group described above may have. The alkyl group represented by R³³ and R³⁴ may be linear, branched, or cyclic. The number of carbon atoms of the alkyl group represented by R³³ and R³⁴ is preferably 1 to 20, and more preferably 1 to 10.

The aryl group represented by R³³ and R³⁴ may be unsubstituted or may have a substituent. The substituent which the aryl group may have is the same as the above-described substituent which the aryl group described above may have. The number of carbon atoms of the aryl group represented by R 33 and R³⁴ is preferably 6 to 15, and more preferably 6 to 10. Specific examples of the aryl group represented by R³³ and R³⁴ include a naphthyl group, a phenyl group, and a tolyl group.

R³⁵ and R³⁶ in “—CR³⁵R³⁶—” represented by X² are the same as R³³ and R³⁴.

The cycloalkylidene group represented by X² in a case where the alkyl groups of R³⁵ and R³⁶ are bonded to each other to form a ring may have a branched structure, and may be unsubstituted or may have a substituent. The substituent which the cycloalkylidene group may have is the same as the substituent which the alkyl group may have. The number of carbon atoms of the cycloalkylidene group represented by X² is preferably 3 to 20, and more preferably 5 to 10. Specific examples of the cycloalkylidene group include a cyclopentylidene group and a cyclohexylidene group.

Among these, R³³ and R³⁴ each independently represent a hydrogen atom or a methyl group, and X² is preferably-CR³⁵R³⁶—(R³⁵ and R³⁶ each independently represent a hydrogen atom or a methyl group), and R³³ and R³⁴ each independently represent a hydrogen atom or a methyl group, and X² is more preferably 2,2-propylidene group (in a case where R³⁵ and R³⁶ of —CR³⁵R³⁶— each are a methyl group).

For example, the polycarbonate resin composition (I) may contain 5 to 100 mass % of the carbonate structural unit (A), 0 to 95 mass % of the carbonate structural unit (B), and 0 to 75 mass % of the carbonate structural unit (C). The polycarbonate resin composition (I) preferably contains 10 to 50 mass % of the carbonate structural unit (A), 25 to 60 mass % of the carbonate structural unit (B), and 0 to 65 mass % of the carbonate structural unit (C). The content of each carbonate structural unit can be calculated by 1H-NMR or the like.

The polycarbonate resin composition (I) may contain the carbonate structural unit (A), the carbonate structural unit (B), and the carbonate structural unit (C), and may be a polycarbonate resin composition containing 5 to 50 mass % of the carbonate structural unit (A), 25 to 60 mass % of the carbonate structural unit (B), and 5 to 65 mass % of the carbonate structural unit (C), or a polycarbonate resin composition containing 10 to 40 mass % of the carbonate structural unit (A), 30 to 55 mass % of the carbonate structural unit (B), and 10 to 55 mass % of the carbonate structural unit (C).

A specific form of the polycarbonate resin composition (I) is not particularly limited, and examples thereof include the following PC(I-p), PC(I-cp), PC(I-m1), and PC(I-m2).

PC(I-p1): a polycarbonate resin of a homopolymer containing two or more conjugated diene structures

PC(I-cp1): a polycarbonate resin of a copolymer containing two or more conjugated diene structures and the carbonate structural unit (B) and/or another carbonate structural unit

PC(I-m1): a mixture of PC(I-p1) and a polycarbonate resin containing the carbonate structural unit (B) and/or another carbonate structural unit

PC(I-m2): a mixture of PC(I-cp1) and a polycarbonate resin containing the carbonate structural unit (B) and/or another carbonate structural unit

More specific examples of the polycarbonate resin composition (I) include the following PC(I-p2), PC(I-cp2), PC(I-m3), and PC(I-m4).

PC(I-p2): a polycarbonate resin of a homopolymer containing the carbonate structural unit (A)

PC(I-cp2): a polycarbonate resin of a copolymer containing the carbonate structural unit (A) and the carbonate structural unit (B) and/or the carbonate structure unit (C)

PC(I-m3): a mixture of PC(I-p2) and a polycarbonate resin containing the carbonate structural unit (B) and/or the carbonate structure unit (C)

PC(I-m4): a mixture of PC(I-cp2) and a polycarbonate resin containing the carbonate structural unit (B) and/or the carbonate structure unit (C)

The polycarbonate resin composition (I) is preferably a copolymer or mixture, and among the above examples, PC(I-cp1), PC(I-cp2), PC(I-m1), PC(I-m2), PC(I-m3), or PC(I-m4) is preferred.

### (Additional Component)

The polycarbonate resin composition (I) may contain an additional component as necessary as long as the desired physical properties are not significantly impaired. Examples of the additional component include various resin additives, and resins other than the polycarbonate resin.

Examples of the resin additives include a heat stabilizer, an antioxidant, a mold release agent, a light stabilizer (HALS), a flame retardant, an antistatic agent, an antifogging agent, a lubricant, an anti-blocking agent, a fluidity improver, a plasticizer, a dispersant, an antibacterial agent, a dye, and a pigment. One type of the resin additive may be contained, or two or more types thereof may be contained in any combination and in any ratio.

Examples of the other resins include: thermoplastic polyester resins such as a polyethylene terephthalate resin, polytrimethylene terephthalate, and a polybutylene terephthalate resin; styrene-based resins such as a polystyrene resin, a high-impact polystyrene resin (HIPS), an acrylonitrile-styrene copolymer (AS resin), an acrylonitrile-styrene-acrylic rubber copolymer (ASA resin), and an acrylonitrile-ethylene propylene-based rubber-styrene copolymer (AES resin); polyolefin resins such as a polyethylene resin and a polypropylene resin; polyamide resins; polyimide resins; polyetherimide resins; polyurethane resins; polyphenylene ether resins; polyphenylene sulfide resins; polysulfone resins; and polymethacrylate resins. One type of the other resin may be contained, or two or more types thereof may be contained in any combination and in any ratio.

### (Molecular Weight of Polycarbonate Resin Composition (I))

A viscosity average molecular weight of the polycarbonate resin composition (I) is preferably 10000 to 50000 in terms of a viscosity average molecular weight (Mv) converted from a solution viscosity. When the viscosity average molecular weight (Mv) is the above lower limit value or more, the mechanical strength of the polycarbonate resin composition of the present invention becomes good, which is preferred. When the viscosity average molecular weight is larger than the above upper limit, it may be difficult in terms of production.

### <Compound (II) Having Two or More Dienophile Groups>

As the compound (II) having two or more dienophile groups (hereinafter sometimes simply referred to as “compound (II)”), any structure can be applied as long as it is a structure that causes the Diels-Alder reaction, but a compound having a maleimide skeleton having good reactivity is preferred, and for example, a compound having a dienophile group having a structure represented by Formula (5) is preferred.

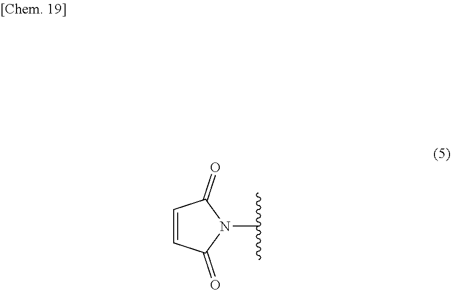 [SMILES: *N1C(=O)C=CC1=O]

In addition, the compound (II) is preferably a compound represented by Formula (II-1) because two or more maleimide skeletons are contained in the compound.

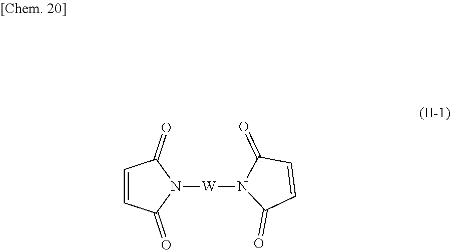

In Formula (II-1), W represents a single bond or a divalent linking group consisting of 1 to 30 carbon atoms, 0 to 2 oxygen atoms, and a hydrogen atom.

Specific examples of W in Formula (II-1) include an alkylene group, an arylene group, and a divalent linking group represented by Formula (II-2).

The alkylene group represented by W may be unsubstituted or may have a substituent, and may be linear, branched, or cyclic. The arylene group represented by W may be unsubstituted or may have a substituent. The substituent which the alkylene group or the arylene group may have is the same as the substituent which the alkyl group or the aryl group may have. The number of carbon atoms of the alkylene group represented by W may be 1 to 30 or 1 to 10, and the number of carbon atoms of the arylene group represented by W may be 6 to 30 or 6 to 10.

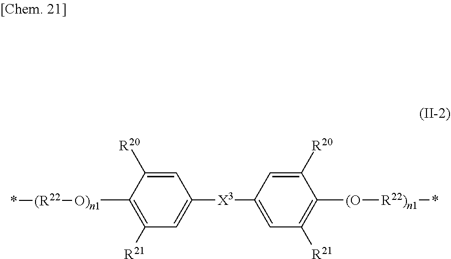

In Formula (II-2), R²⁰ and R²¹ each independently represent a hydrogen atom, an alkyl group, or an aryl group, R²² is an alkylene group or an arylene group, n1 represents an integer of 0 or 1, and X³ represents a single bond, —CR³⁰R³¹— (R³⁰ and R³¹ each independently represent a hydrogen atom, an alkyl group, or an aryl group), or a cycloalkylidene group. Note that the symbol * represents a position of linkage to another atom.

The alkyl group represented by R²⁰ and R²¹ may be unsubstituted or may have a substituent, and may be linear, branched, or cyclic. The aryl group represented by R²⁰ and R²¹ may be unsubstituted or may have a substituent. The substituent which the alkyl group or the aryl group represented by R 20 or R²¹ may have is the same as the substituent which the alkyl group or the aryl group described above may have. The number of carbon atoms of the alkyl group represented by R²⁰ and R²¹ may be 1 to 8 or 1 to 6, and the number of carbon atoms of the aryl group represented by R²⁰ and R²¹ may be 6 to 8.

The alkyl group and the aryl group represented by R³⁰ and R³¹ of “—CR³⁰R³¹—” of X³ are the same as those of R²⁰ and R²¹. The cycloalkylidene group represented by X³ may have a branched structure, and may be unsubstituted or may have a substituent. The substituent which the cycloalkylidene group may have is the same as the substituent which the alkyl group may have. The number of carbon atoms of the cycloalkylidene group represented by X³ may be 3 to 10 or 5 to 8.

The alkylene group represented by R²² may be unsubstituted or may have a substituent, and may be linear, branched, or cyclic. The arylene group represented by R²² may be unsubstituted or may have a substituent. The substituent which the alkylene group or the arylene group may have is the same as the substituent which the alkyl group or the aryl group may have. The alkylene group represented by R²² may have 1 to 8 or 1 to 6 carbon atoms, and the arylene group represented by R²² may have 6 to 8 carbon atoms.

Specific examples of the compound (II) having two or more maleimide skeletons include bis(3-ethyl-5-methyl-4-maleimidophenyl) methane, 4,4′-bismaleimidodiphenylmethane, N,N′-1,3-phenylenedimaleimide, and 2,2-bis [4-(4-maleimidophenoxy)phenyl]propane.

### <Polycarbonate Resin Composition of First Embodiment>

Examples of the polycarbonate resin composition of the first embodiment include a composition containing a reaction product produced by subjecting one or more polycarbonate resin compositions (I) selected from the group consisting of PC(I-p1), PC(I-p2), PC(I-cp1), PC(I-cp2), PC(I-m1), PC(I-m2), PC(I-m3), and PC(I-m4) and a compound (II) having two or more dienophile groups to the Diels-Alder reaction.

More preferable examples of the polycarbonate resin composition of the first embodiment include the following two types.

1) A polycarbonate resin composition produced by subjecting a polycarbonate resin mixture of a polycarbonate resin containing the carbonate structural unit (B) and a polycarbonate resin containing two or more conjugated diene structures to the Diels-Alder reaction with the compound (II) having a dienophile structure.

2) A polycarbonate resin composition produced by subjecting a copolymerized polycarbonate resin having the carbonate structural unit (B) and two or more conjugated diene structures to the Diels-Alder reaction with the compound (II) having a dienophile structure.

When an amount of the compound (II) having two or more dienophile groups is too small relative to the structural unit of the conjugated diene in the polycarbonate resin composition (I), the self-healing property is lowered, and when the amount is too large, the excessive compound (II) having dienophile groups may float on the surface when formed into a film or the like. Accordingly, the proportion of the polycarbonate resin composition (I) and the compound (II) having two or more dienophile groups are preferably 10 to 200 mol parts, and more preferably 30 to 120 mol parts of the compound (II) having two or more dienophile groups relative to 100 mol parts of the structural unit of the conjugated diene in the polycarbonate resin composition (I).

### Second Embodiment

The bond between polymer chains of the polycarbonate resin composition of the second embodiment is formed by the reaction between the polycarbonate resin composition (III) having two or more dienophile structures and the compound (IV) having two or more conjugated diene groups.

That is, the polycarbonate resin composition of the second embodiment is a composition containing a reaction product produced by subjecting the polycarbonate resin composition (III) having two or more dienophile structures and the compound (IV) having two or more conjugated diene groups to the Diels-Alder reaction.

### <Polycarbonate Resin Composition (III) Having Two or More Dienophile Structures>

The polycarbonate resin composition (III) having two or more dienophile structures (hereinafter, sometimes simply referred to as “polycarbonate resin composition (III)”) may contain two or more dienophile structures derived from a compound containing one dienophile structure, or may contain dienophile structures derived from a compound containing two dienophile structures. The polycarbonate resin composition (III) may be a homopolymer of a polycarbonate resin, a copolymer of a polycarbonate resin, or a mixture containing two or more polycarbonate resins, as long as it contains two or more dienophile structures.

### (Dienophile Structure)

The dienophile structure contained in the polycarbonate resin composition (III) is preferably a dienophile structure represented by Formula (5).

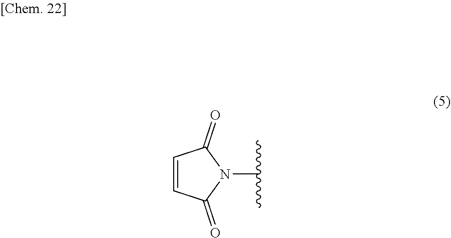 [SMILES: *N1C(=O)C=CC1=O]

A general example of such a polycarbonate resin composition (III) includes a polycarbonate resin composition having a dienophile structure represented by Formula (5) introduced into a terminal of a polycarbonate resin.

As the dienophile structure, any structure can be applied as long as it is a structure that causes the Diels-Alder reaction, but a structure having a maleimide skeleton is preferable from the viewpoint of high reactivity.

Examples of the dienophile structure include bismaleimides such as 4,4′-diphenylmethane bismaleimide, m-phenylene bismaleimide, 2,2-bis [4-(4-maleimidophenoxy)phenyl]propane, bisphenol A diphenyl ether bismaleimide, 3,3′-dimethyl-5,5′-diethyl-4,4′-diphenylmethane bismaleimide, 4-methyl-1,3-phenylene bismaleimide, 1,6-bismaleimide-(2,2,4-trimethyl) hexane, 4,4′-diphenyl ether bismaleimide, 4,4′-diphenylsulfone bismaleimide, 1,3-bis(3-maleimidophenoxy)benzene, 1,3-bis(4-maleimidophenoxy)benzene, diphenylmethane-4,4′-bismaleimide polymer having 4,4′-methylenedianiline, N,N′-(2,2′-diethyl-6,6′-dimethyldiphenylene)bismaleimide, N,N′-(4-methyl-m-phenylene)bismaleimide, N,N′-m-phenylenedimaleimide, N,N′-m-phenylenebismaleimide, and polyphenylmethane bismaleimide, and monomaleimides such as N-phenylmaleimide.

The dienophile structure in the polycarbonate resin composition (III) is preferably a structure containing a structure represented by Formula (5B), which is produced by using a hydroxy compound represented by Formula (5A) as an end capping agent, from the viewpoint of ease of synthesis.

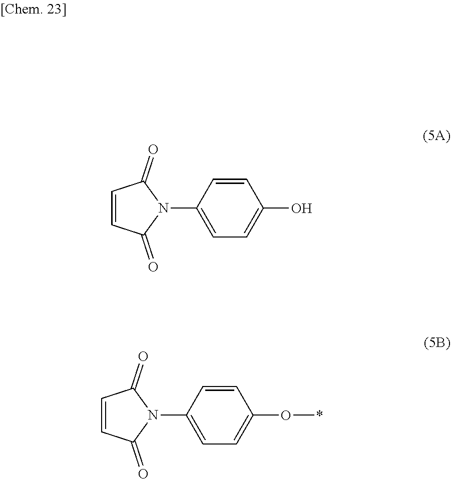 [SMILES: O=C1C=CC(=O)N1c1ccc(O)cc1 ; *Oc1ccc(N2C(=O)C=CC2=O)cc1]

One of these polycarbonate resin composition (III) may be used alone, or two or more thereof may be used.

### <Compound (IV) Having Two or More Conjugated Diene Groups>

### (Conjugated Diene Group)

As the conjugated diene group of the compound (IV) having two or more conjugated diene groups (hereinafter, sometimes simply referred to as “compound (IV)”), any group can be applied as long as it is a group that causes the Diels-Alder reaction, but a group having a furan skeleton, an anthracene skeleton, or a styryl skeleton is preferable, and a group having a furan skeleton that has a favorable self-healing property even at a low temperature is particularly preferable.

More specifically, the compound (IV) preferably has two or more conjugated diene structures represented by any one of Formulae (2), (3), and (4)

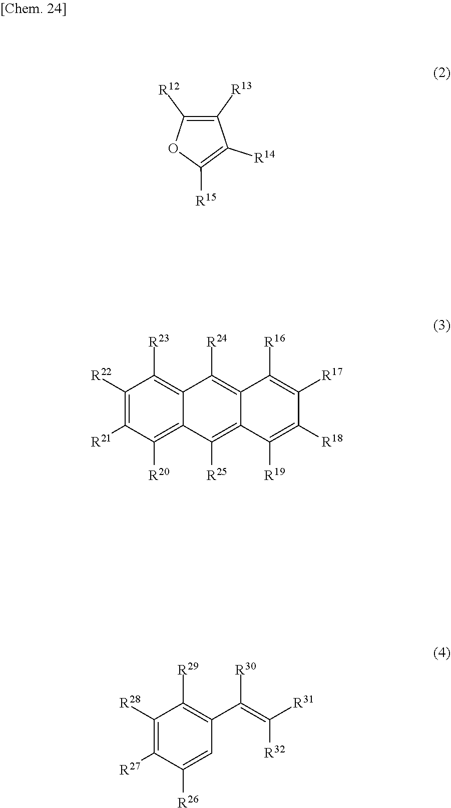

In Formula (2), R¹² to R¹⁵ each independently represent a single bond, a bonding group to another skeleton, a hydrogen atom, an aliphatic hydrocarbon group having 1 to 12 carbon atoms, an aromatic hydrocarbon group having 6 to 12 carbon atoms, or an alkoxy group having 1 to 10 carbon atoms. One or two of R¹² to R¹⁵ are a single bond or a bonding group to another skeleton;

In Formula (3), R¹⁶ to R²⁵ each independently represent a single bond, a bonding group to another skeleton, a hydrogen atom, an aliphatic hydrocarbon group having 1 to 12 carbon atoms, an aromatic hydrocarbon group having 6 to 12 carbon atoms, or an alkoxy group having 1 to 10 carbon atoms. One or two of R¹⁶ to R²⁵ are a single bond or a bonding group to another skeleton.

In Formula (4), R²⁶ to R³² each independently represent a single bond, a bonding group to another skeleton, a hydrogen atom, an aliphatic hydrocarbon group having 1 to 12 carbon atoms, an aromatic hydrocarbon group having 6 to 12 carbon atoms, or an alkoxy group having 1 to 10 carbon atoms. One or two of R²⁶ to R³² are a single bond or a bonding group to another skeleton.

The above Formulae (2), (3) and (4) are the same as Formulae (2), (3) and (4) in the polycarbonate resin composition (I).

Examples of the compound (IV) having two or more conjugated diene groups include 2,2′-(2,5-dimethyl-p-phenylene)bisfuran, 2,5-bis(2-furyl) toluene, difurfurylamine, and 1,4-bis(2-methylstyryl)benzene. One of these compound (IV) may be used alone, or two or more thereof may be used.

In the polycarbonate resin composition of the second embodiment as well, as in the first embodiment, when an amount of the polycarbonate resin composition (III) is too small relative to the conjugated diene group in the compound (IV), the self-healing property is lowered, and when the amount is too large, the excessive polycarbonate resin composition (III) may float on the surface when formed into a film or the like. Thus, the proportion of the compound (IV) and the polycarbonate resin composition (III) structure is preferably 10 to 200 mol parts, and more preferably 30 to 120 mol parts of the polycarbonate resin composition (III) relative to 100 mol parts of the conjugated diene group of the compound (IV).

A method for producing the polycarbonate resin composition of the second embodiment by forming a bond between polymer chains by the Diels-Alder reaction using the polycarbonate resin composition (III) and the compound (IV) is the same as that of the first embodiment described above, and examples thereof include the following method.

The polycarbonate resin composition (III) has a dienophile structure in the polymer, and the dienophile structure is generally introduced into the terminal. For example, the polycarbonate resin composition (III) having a dienophile structure introduced therein is synthesized by a polycarbonate polymerization method known in the related art using a hydroxy compound represented by Formula (5A) as an end capping agent. Thereafter, the polycarbonate resin composition of the second embodiment is produced by the Diels-Alder reaction with the compound (IV).

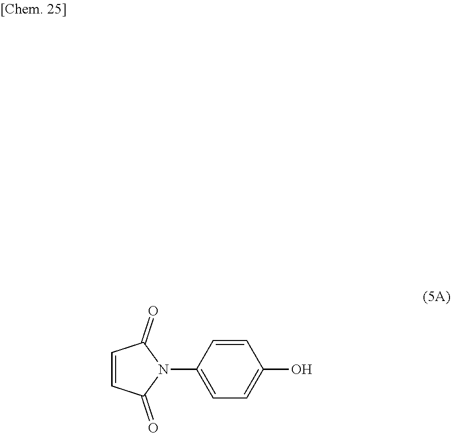 [SMILES: O=C1C=CC(=O)N1c1ccc(O)cc1]

### Third Embodiment

The bond between polymer chains of the polycarbonate resin composition of the third embodiment is formed by the reaction between the polycarbonate resin composition (I) having two or more conjugated diene structures and the polycarbonate resin composition (III) having two or more dienophile structures.

That is, the polycarbonate resin composition of the third embodiment is a composition containing a reaction product produced by subjecting the polycarbonate resin composition (I) having two or more conjugated diene structures and the polycarbonate resin composition (III) having two or more dienophile structures to the Diels-Alder reaction.

The description of the polycarbonate resin composition (I) in the first embodiment is applied to the polycarbonate resin composition (I) in the third embodiment.

The description of the polycarbonate resin composition (III) in the second embodiment is applied to the polycarbonate resin composition (III).

In the polycarbonate resin composition of the third embodiment as well, as in the first and second embodiments, when an amount of the polycarbonate resin composition (III) having two or more dienophile structures is too small relative to the structural unit of the conjugated diene in the polycarbonate resin composition (I), the self-healing property is lowered, and when the amount is too large, the excessive polycarbonate resin composition (III) having an dienophile structure may float on the surface when formed into a film or the like. Thus, the proportion of the polycarbonate resin composition (I) and the polycarbonate resin composition (III) having two or more dienophile structures is preferably 10 to 200 mol parts, and more preferably 30 to 120 mol parts of the polycarbonate resin composition (III) having two or more dienophile structures relative to 100 mol parts of the structural unit of the conjugated diene of the polycarbonate resin composition (I).

A method for producing the polycarbonate resin composition of the third embodiment by forming a bond between polymer chains by the Diels-Alder reaction using the polycarbonate resin composition (I) and the polycarbonate resin composition (III) is the same as in the first embodiment and the second embodiment described above, and examples thereof include the following method.

The polycarbonate resin composition (I) having a conjugated diene structure is synthesized by a polycarbonate polymerization method known in the related art using a dihydroxy compound having a conjugated diene group. In addition, the polycarbonate resin composition (III) having a dienophile structure is synthesized by a polycarbonate polymerization method known in the related art using a compound having a dienophile group. In general, the dienophile structure is introduced into the terminal. For example, a hydroxy compound represented by Formula (5A) is used as the end capping agent. The polycarbonate resin composition of the third embodiment is produced by the Diels-Alder reaction using the produced polycarbonate resin composition (I) and the produced polycarbonate resin composition (III).

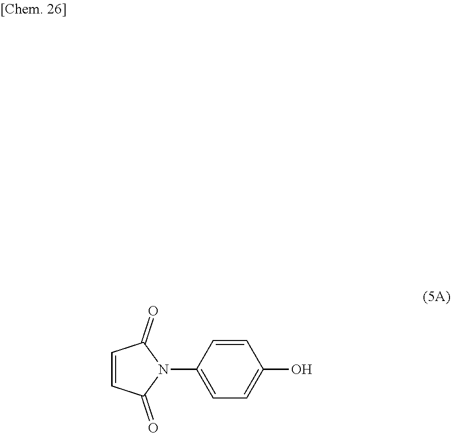 [SMILES: O=C1C=CC(=O)N1c1ccc(O)cc1]

### [Method for Producing Polycarbonate Resin Composition of the Present Invention]

A method for producing a polycarbonate resin composition of the present invention is not particularly limited. An example thereof is a production method including a first step of producing a polycarbonate resin composition (I) having two or more conjugated diene structures, and a second step of subjecting the polycarbonate resin composition (I) having two or more conjugated diene structures produced in the first step and a compound (II) having two or more dienophile groups to a Diels-Alder reaction to produce a polycarbonate resin composition having a bond between polymer chains by the Diels-Alder reaction (hereinafter, sometimes referred to as “the method for producing a polycarbonate resin composition of the present invention”).

That is, the method for producing a polycarbonate resin composition of the present invention is performed in two stages. The first stage is preparation of a polycarbonate resin or a polycarbonate resin composition before the Diels-Alder reaction, and the second stage is production of a polycarbonate resin composition having a bond between polymer chains by the Diels-Alder reaction.

### <First Step (First Stage)>

The first step is a step of producing a polycarbonate resin composition (I) having two or more conjugated diene structures. In a case where the target polycarbonate resin composition (I) is a homopolymer or a copolymer, in the first step, a polycarbonate resin is produced by a known polymerization method. In a case where the target polycarbonate resin composition (I) is a mixture of a plurality of polycarbonate resins, in the first step, a plurality of polycarbonate resins are produced by a known polymerization method, and then the plurality of polycarbonate resins thus produced are mixed to produce a mixture.

### (Method for Producing Polycarbonate Resin)

The polycarbonate resin constituting the polycarbonate resin composition of the present invention can be produced by a polymerization method known in the related art, and the polymerization method is not particularly limited. Examples of the polymerization method include an interfacial polymerization method, a melt transesterification method, a pyridine method, a ring-opening polymerization method of a cyclic carbonate compound, and a solid phase transesterification method of a prepolymer. From the viewpoint of polymerizability, the melt transesterification method is preferred. Hereinafter, the melt transesterification method will be specifically described.

### (Melt Transesterification Method)

In the melt transesterification method, for example, a transesterification reaction of a carbonate ester and a raw material dihydroxy compound is performed.

The polycarbonate resin can be produced by using a raw material dihydroxy compound containing a dihydroxy compound having a conjugated diene structure. As the dihydroxy compound having a conjugated diene structure, a dihydroxy compound represented by the above gation M100Formula (A-1) or the like is used. In addition, a copolymerized polycarbonate resin can be produced by using another dihydroxy compound such as the alkylene diol or polyalkylene ether glycol represented by the above Formula (B-1) or the dihydroxy compound represented by the above Formula (C-1).

The carbonate ester only needs to be, for example, a compound represented by Formula (D-1), and examples thereof include diaryl carbonates, dialkyl carbonates, biscarbonate forms of dihydroxy compounds, monocarbonate forms of dihydroxy compounds, and carbonate forms of dihydroxy compounds such as cyclic carbonate.

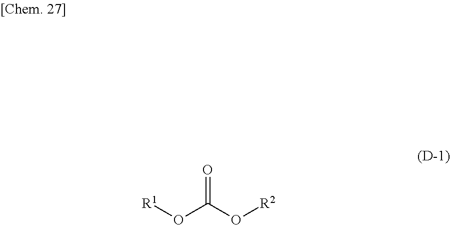

In Formula (D-1), R¹ and R² each independently represent an alkyl group or an aryl group. The alkyl group represented by R¹ and R² may be unsubstituted or may have a substituent, and may be linear, branched, or cyclic. The aryl group represented by R¹ and R² may be unsubstituted or may have a substituent. The substituent which the alkyl group or the aryl group represented by R¹ and R² may have is the same as the substituent which the alkyl group or the aryl group may have. The number of carbon atoms of the alkyl group represented by R¹ and R² is preferably 1 to 30, and the number of carbon atoms of the aryl group represented by R¹ and R² is preferably 6 to 20.

Hereinafter, when R¹ and R² are alkyl groups, the carbonate is sometimes referred to as a dialkyl carbonate, and when they are aryl groups, the carbonate is sometimes referred to as a diaryl carbonate.

Among them, from the viewpoint of reactivity with the dihydroxy compound, the carbonate ester is more preferably a diaryl carbonate which is represented by Formula (D-2) and may have a substituent.

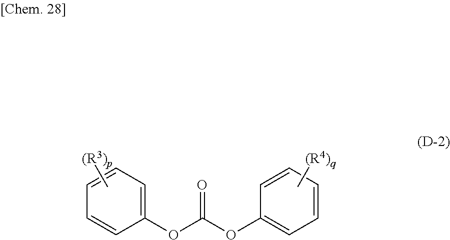

In Formula (D-2), R³ and R⁴ each independently represent a halogen atom, a nitro group, a cyano group, an alkyl group having 1 to 20 carbon atoms, an aryl group having 6 to 20 carbon atoms, a carboxylic acid group, an alkoxycarbonyl group having 2 to 20 carbon atoms, or an acyloxy group having 1 to 20 carbon atoms, and p and q each independently represent an integer of 0 to 5.

An alkoxycarbonyl group is a group represented by —C(═O)—OR⁵ (R⁵ is an alkyl group), and specific examples thereof include a methoxycarbonyl group and an ethoxycarbonyl group. An acyloxy group is a group represented by —O—C(═O)—R⁶ (R⁶ is a hydrogen atom, an alkyl group, or an aryl group), and specific examples thereof include a formyloxy group and an acetyloxy group. In addition, p and q are each independently preferably an integer of 0 to 3, and more preferably an integer of 0 to 2.

Specific examples of the carbonate ester represented by Formula (D-1) or (D-2) include dialkyl carbonates such as dimethyl carbonate, diethyl carbonate, and di-t-butyl carbonate, and diaryl carbonates such as diphenyl carbonate (hereinafter, sometimes abbreviated as “DPC”), bis(4-methylphenyl) carbonate, bis(4-chlorophenyl) carbonate, bis(4-fluorophenyl) carbonate, bis(2-chlorophenyl) carbonate, bis(2,4-difluorophenyl) carbonate, bis(4-nitrophenyl) carbonate, bis(2-nitrophenyl) carbonate, bis(methylsalicylphenyl) carbonate, and ditolyl carbonate, and among these, diphenyl carbonate is preferable. Note that one of these carbonate esters may be used alone, or two or more thereof may be used in a mixture.

The carbonate ester may be substituted with a dicarboxylic acid or a dicarboxylic acid ester in an amount of preferably 50 mol % or less, and more preferably 30 mol % or less. Typical examples of the dicarboxylic acid or dicarboxylic acid ester include terephthalic acid, isophthalic acid, diphenyl terephthalate, and diphenyl isophthalate. In a case where the carbonate ester is substituted with such a dicarboxylic acid or dicarboxylic acid ester, polyester carbonate is produced.

The ratio of the raw material dihydroxy compound and the carbonate ester is freely selected as long as the desired polycarbonate resin is produced, but it is preferable to use the carbonate ester in excess relative to the raw material dihydroxy compound when polymerized with the dihydroxy compound. That is, the amount of the carbonate ester is preferably 1.00 to 1.30 mol, and more preferably 1.02 to 1.20 mol, relative to 1 mol of the dihydroxy compound. When this molar ratio is too small, the terminal OH groups of the resulting polycarbonate resin increase, and thermal stability of the resin tends to deteriorate. On the other hand, when this molar ratio is too large, the reaction rate of the transesterification may decrease. Due to this, it may be difficult to produce a polycarbonate resin having a desired molecular weight. In addition, the amount of the carbonate ester remaining in the resin may increase, causing odor during molding or when a molded article is formed.

When a polycarbonate resin is produced by the melt transesterification method, a transesterification catalyst is usually used. The transesterification catalyst is not particularly limited, and a catalyst known in the related art can be used. For example, an alkali metal compound and/or an alkaline earth metal compound is preferably used. Further, a basic compound such as a basic boron compound, a basic phosphorus compound, a basic ammonium compound, or an amine-based compound may be used in combination as an auxiliary. Note that only one type of the transesterification catalyst may be used, or two or more types thereof may be used in any combination and ratio.

In the melt transesterification method, the reaction temperature is not particularly limited, but is usually 100 to 300° C. The pressure during the reaction is not particularly limited, but is usually a reduced pressure condition of 2 mmHg or less. As a specific operation, the melt polycondensation reaction only needs to be performed under the above-described conditions while removing by-products.

Here, the polycarbonate resin composition is significantly affected by thermal history and oxidation in the presence of an alkali catalyst, leading to deterioration of hue. Thus, it is preferable to set the reaction temperature to 300° C. or lower and to select a reduced pressure condition with a lower limit of about 0.05 mmHg to prevent oxygen leakage from the equipment due to excessive pressure reduction.

The reaction can be performed in either a batch system or a continuous system. In a case of the batch system, the order of mixing a reaction substrate (reaction raw material), a catalyst, an additive, and the like is freely selected as long as the desired polycarbonate resin is produced, and an appropriate order only needs to be appropriately set.

In the melt transesterification method, a catalyst deactivator may be used as necessary. As the catalyst deactivator, a compound that neutralizes the transesterification catalyst can be optionally used. Examples thereof include a sulfur-containing acidic compound and a derivative thereof, and a phosphorus-containing acidic compound and a derivative thereof. Note that one type of the catalyst deactivators may be used, or two or more types thereof may be used in any combination and ratio.

The amount of the catalyst deactivator to be used is not particularly limited, but is usually 0.5 equivalent or more, preferably 1 equivalent or more, and more preferably 3 equivalents or more, and is usually 50 equivalents or less, preferably 10 equivalents or less, and more preferably 8 equivalents or less, relative to the transesterification catalyst.

### (Method for Producing Polycarbonate Resin Mixture)

In a case where the target polycarbonate resin composition (I) is a mixture of a plurality of polycarbonate resins, a method for producing the mixture is not particularly limited, but examples of the method for producing the polycarbonate resin composition (I) by mixing two types of polycarbonate resins, namely a polycarbonate resin (a) and a polycarbonate resin (b), usually include the following methods 1) to 4).
1) Method of mixing the polycarbonate resin (a) and the polycarbonate resin (b) in a solution state
2) Method of melt-kneading the polycarbonate resin (a) in a molten state and the polycarbonate resin (b) in a molten state
3) Method of melt-kneading the polycarbonate resin (a) and the polycarbonate resin (b)
4) Method of dry-blending the polycarbonate resin (a) and the polycarbonate resin (b)

The methods 1) to 4) can be appropriately selected depending on types of the polycarbonate resins to be mixed. For example, in a case where a mixture of a polycarbonate resin containing two or more conjugated dienes and a polycarbonate resin containing the carbonate structural unit (B) is produced, the methods 1) and 2) are preferred because the polycarbonate resin containing the carbonate structural unit (B) has a low glass transition temperature.

Hereinafter, the methods 1) and 2) will be described.

1) Method of mixing the polycarbonate resin (a) and the polycarbonate resin (b) in a solution state;
In this method, the polycarbonate resin (a) and the polycarbonate resin (b) are dissolved in an appropriate solvent to form a solution, and are mixed in the solution state, and then a polycarbonate resin composition is isolated. Examples of suitable solvents include: aliphatic hydrocarbons such as hexane and n-heptane; chlorinated aliphatic hydrocarbons such as dichloromethane, chloroform, carbon tetrachloride, dichloroethane, trichloroethane, tetrachloroethane, dichloropropane, and 1,2-dichloroethylene; aromatic hydrocarbons such as benzene, toluene, and xylene; and substituted aromatic hydrocarbons such as nitrobenzene and acetophenone. Among these, for example, chlorinated hydrocarbons such as dichloromethane or chlorobenzene are suitably used. These solvents can be used alone or as a mixture with another solvent.

Examples of a mixing apparatus include a stirring tank and a static mixer.

The mixing temperature is not particularly limited as long as the polycarbonate resin (a) and the polycarbonate resin (b) are dissolved, and the mixing is usually performed at a temperature equal to or lower than the boiling point of the solvent to be used.

2) Method of melt-kneading the polycarbonate resin (a) in a molten state and the polycarbonate resin (b) in a molten state;
The polycarbonate resin (a) in a molten state and the polycarbonate resin (b) in a molten state are mixed using a mixing apparatus such as a stirring tank, a static mixer, a kneader, a twin-screw extruder, or a single-screw extruder. At this time, for example, the polycarbonate resin produced by a melt polymerization method may be introduced into the mixing apparatus in a molten state without being cooled and solidified. The mixing temperature is not particularly specified, but is preferably 100° C. or higher, more preferably 120° C. or higher, and still more preferably 150° C. or higher. The mixing temperature is preferably 300° C. or lower, and particularly preferably 250° C. or lower. When the mixing temperature is low, the polycarbonate resin (a) and the polycarbonate resin (b) may not be completely mixed, which is not preferable. When the mixing temperature is too high, the color tone of the polycarbonate resin composition may be deteriorated, which is not preferable.

In any of the above methods, a pigment, a dye, a mold release agent, a heat stabilizer, or the like may be added as appropriate within a range that does not impair the object of the present invention.

### <Second Step (Second Stage)>

The second step is a step of subjecting the polycarbonate resin composition (I) having two or more conjugated diene structures produced in the first step and a compound (II) having two or more dienophile groups to a Diels-Alder reaction to produce a polycarbonate resin composition having a bond between polymer chains by the Diels-Alder reaction.

The polycarbonate resin or the polycarbonate resin composition produced in the first step is dissolved in an appropriate solvent to form a solution, is mixed in a solution state, and a compound having a reaction site of the Diels-Alder reaction is added thereto to cause a reaction. Thereafter, the resultant is dried to isolate a polycarbonate resin composition. In a case where the polycarbonate resin composition (I) is prepared by mixing in a solution state in the first step, the compound having a reaction site of the Diels-Alder reaction is continuously added to the polycarbonate resin composition (I) in a solution state to cause a reaction. Thereafter, the resultant is dried to isolate a polycarbonate resin composition, whereby the polycarbonate resin composition of the present invention is produced. Note that the solvent to be used may be any solvent as long as it dissolves the polycarbonate resin, but dichloromethane or chloroform is preferable from the viewpoint of the reactivity of the Diels-Alder reaction.

The method for producing a polycarbonate resin composition of the present invention has been described above by exemplifying the method for producing the polycarbonate resin composition of the first embodiment, but the polycarbonate resin composition of the second embodiment and the polycarbonate resin composition of the third embodiment can also be produced in the same manner.

That is, the second polycarbonate resin composition can be produced by replacing the polycarbonate resin composition (I) with the polycarbonate resin composition (III) and replacing the compound (II) with the compound (IV) in the above description.

The polycarbonate resin composition of the third embodiment can be produced by replacing the compound (II) with the polycarbonate resin composition (III). In any case, a person skilled in the art can perform the production method based on the method for producing the polycarbonate resin composition of the first embodiment.

### EXAMPLES

Hereinafter, the present invention will be more specifically described based on examples. Note that the present invention is not limited to the following examples.

### [Measurement and Evaluation Methods]

The physical properties of the polycarbonate resins produced in the following Examples and Comparative Examples were measured and evaluated by the following methods.

### (1) Viscosity Average Molecular Weight (Mv)

The polycarbonate resin composition was dissolved in methylene chloride (concentration: 6.0 g/L), and an inherent viscosity (limiting viscosity) [η] (in dL/g) at 20° C. was determined using an Ubbelohde viscometer (available from Moritomo Rika Kogyo Co., Ltd.), and the viscosity average molecular weight (Mv) was calculated from a Schnell viscosity equation (the following equation).

$$η = 1.23 \times 1 {0}^{- 4} {Mv}^{0.83}$$

The inherent viscosity (limiting viscosity) [η] refers to a value calculated by the following equation from a specific viscosity [ηsp] measured at each solution concentration [C] (g/dL).

$$η = {lim}_{c \to 0} {η}_{sp} / c \qquad [ Math . 1 ]$$

### (2) Glass Transition Temperature (Tg): Endothermic Onset/End Temperature

Measurement was performed using a differential scanning calorimeter (DSC6220, available from SII). The produced polycarbonate resin composition was used without drying as a measurement sample. An aluminum sample pan containing a measurement sample (10 mg) was cooled from 30° C. to −90° C. at a nitrogen gas flow of 50 mL/min and a temperature lowering rate of 40° C./min, and then heated from −90° C. to 300° C. at a temperature raising rate of 20° C./min.

A differential scanning calorimetry curve obtained during the temperature raising was analyzed as a measurement curve. A glass transition temperature (Tg) was analyzed in accordance with JIS K7121-1987. An extrapolated glass transition onset temperature, which is the temperature of an intersection of a straight line extending the baseline on the low temperature side toward the high temperature side and a tangent drawn at a point where the gradient of a curve of a stepwise change portion of glass transition is maximized, was determined. The extrapolated glass transition temperature was taken as the glass transition temperature (Tg).

The endothermic onset and end temperatures were analyzed as follows. The endothermic onset temperature was defined as the temperature at the intersection of a straight line extending the baseline on the low temperature side toward the high temperature side and a tangent drawn at the point where the gradient of the curve on the low temperature side of the melting peak is maximized. The endothermic end temperature was defined as the temperature at the intersection of a straight line extending the baseline on the high temperature side toward the low temperature side and a tangent drawn at the point where the gradient of the curve on the high temperature side of the melting peak is maximized. In a case where no endothermic peak was detected, the result was expressed as “n.d.”.

### (3) Evaluation of Self-Healing Property

Films each having a diameter of 5 cm prepared in Examples and Comparative Examples were scratched in accordance with ISO 15184 using a pencil hardness tester (available from TOYO SEIKI Co., Ltd.) and a pencil having a pencil hardness of 4H at a load of 750 g. Thereafter, the sample was placed in a hot air dryer and allowed to stand at 30° C. or 70° C. for 6 hours, and the surface of the sample was observed visually and by touch with a finger. When the scratch disappeared and could not be visually confirmed and the scratch could not be confirmed by the tactile sense of the finger, it was evaluated as “∘”. When the scratch could be slightly visually confirmed but could not be confirmed by the tactile sense of the finger, it was evaluated as “Δ”. When the scratch could be confirmed by both the visual sense and the tactile sense of the finger, it was evaluated as “x”. The samples were determined to have a self-healing property when the evaluation was “∘” or “Δ”.

### (4) Test Piece Bending Test

The films produced above were alternately folded in a mountain fold and a valley fold five times, that is, the film was folded ten times in total at the same position. The sample was bent 10 times in total of mountain folds and valley folds, and when the sample was not broken, the sample was evaluated as “∘”, and when the sample was broken or cut, the sample was evaluated as “x”. The mechanical strength was determined to be high when the evaluation was “∘”.

### (5) Solvent Resistance Test

A portion of each of the produced films, 0.1 g, was placed in a 50-mL screw tube, 5 mL of methylene chloride was added thereto, and the resultant was allowed to stand at room temperature for 7 hours. After 7 hours, the sample was visually confirmed. When there was no change in the sample, it was evaluated as “⊚”, when the sample swelled but the shape thereof was maintained, it was evaluated as “∘”. When the shape of the sample was not maintained but there was a gel-like insoluble matter, it was evaluated as “Δ”. When the sample was completely dissolved, it was evaluated as “x”. The samples were determined to have solvent resistance when the evaluation was (“⊚”, “∘”, or “Δ”.

### (6) Film Thickness

A thickness of each of the produced films was measured at three points freely selected, and the average value of the three points was calculated.

Hereinafter, compounds used in Examples and Comparative Examples are represented by the following abbreviations.

Compounds of the following manufacturers were used.

As Bis26X-FF described below, one synthesized on a laboratory scale was used. Examples of synthesis are described below.

### <Dihydroxy Compound>

Bis26X-FF: bis(3,5-dimethyl-4-hydroxyphenyl)-2-furylmethane BIP-ANT: 4-[[10-(4-hydroxyphenyl)-9-anthracenyl]methyl]phenol (available from ASAHI YUKIZAI CORPORATION)
BPA: 2,2′-bis(4-hydroxyphenyl) propane (bisphenol A) (available from Mitsubishi Chemical Corporation)
BisB: 2,2-bis(4-hydroxyphenyl) butane (available from Honshu Chemical Industry Co., Ltd.)
DHDE: 4,4′-dihydroxydiphenyl ether (available from Chemfish)
PO3G1000: polytrimethylene ether glycol, number average molecular weight 1110 (available from ALLESSA GmbH, article name: VELVETOL (trade name))
PO3G2700: polytrimethylene ether glycol, number average molecular weight 2723 (available from ALLESSA GmbH, article name: VELVETOL (trade name))

### <Carbonate Ester>

DPC: diphenyl carbonate (available from Mitsubishi Chemical Corporation)

### Polymerization Catalyst

Cesium carbonate (available from Kishida Chemical Co., Ltd.)

### <Compound Having Dienophile Group>

Bismaleimide: bis(3-ethyl-5-methyl-4-maleimidophenyl) methane (available from Tokyo Chemical Industry Co., Ltd.)

### Synthesis Example of Bis26X-FF

In a 200-mL three-necked round-bottomed flask equipped with a reflux tube, a dropping funnel, a stirrer chip, and a thermometer and purged with nitrogen, 61.1 g of 2,6-xylenol and 32.0 g of methanol were placed, and 2.0 g of sodium hydroxide was added thereto and dissolved with stirring. Thereafter, the resultant was refluxed with heat at 80° C., and 24.0 g of furfural was added dropwise over 2 hours using a dropping funnel. After the dropwise addition, the mixture was stirred for 5 hours, cooled until the internal temperature became 50° C. or lower, and neutralized by adding 70 g of 20% aqueous sodium dihydrogen phosphate solution. The resulting precipitate was collected by filtration, washed with a methanol/water mixture in a mass ratio of 1:1, and dried in a vacuum dryer to produce the target product.

### Example 1

Into a glass reactor equipped with a reactor stirrer, a reactor heater, a reactor pressure regulator and having an internal volume of 570 mL, 15.23 g (about 0.0472 mol) of Bis26X-FF, 32.35 g (about 0.142 mol) of BPA, 52.43 g (about 0.0472 mol) of PO3G1000, 52.11 g (about 0.243 mol) of DPC, and 4.0 mass % aqueous solution of cesium carbonate as a catalyst was added in such a manner that the concentration of cesium carbonate was 150 μmol per mol of all the dihydroxy compound, thereby preparing a raw material mixture.

Next, the inside of the glass reactor was depressurized to about 50 Pa (0.38 Torr), and then the pressure was returned to atmospheric pressure with nitrogen. This operation was repeated three times to purge the inside of the reactor with nitrogen. After the nitrogen purge, the reactor external temperature was set to 220° C., and the reactor internal temperature was gradually raised to dissolve the mixture. Thereafter, the stirrer was rotated at 100 rpm. Then, the pressure in the reactor was reduced from 101.3 kPa (760 Torr) to 13.3 kPa (100 Torr) in terms of absolute pressure over 40 minutes while distilling off phenol produced as a by-product by an oligomerization reaction of the dihydroxy compound and DPC performed in the reactor.

Subsequently, the pressure in the reactor was maintained at 13.3 kPa, and a transesterification reaction was performed for 80 minutes while further distilling off phenol. Thereafter, the reactor external temperature was raised to 260° C., and the pressure inside the reactor was reduced from 13.3 kPa (100 Torr) to 399 Pa (3 Torr) in terms of absolute pressure over 40 minutes, thereby removing distilled phenol out of the system. Further, the absolute pressure in the reactor was reduced to 30 Pa (about 0.2 Torr), and a polycondensation reaction was performed. When the stirrer of the reactor reached a predetermined stirring power, the polycondensation reaction was terminated.

Then, the pressure in the reactor was returned to 101.3 kPa in terms of absolute pressure and then raised to 0.2 MPa in terms of gauge pressure, and the polycarbonate resin was taken out from the bottom of the reactor.

Thereafter, 3 g of the produced polycarbonate resin was dissolved in 15 mL of methylene chloride in a 50-mL screw vial, and 0.295 g of bismaleimide was added thereto. After the addition, 15 hours elapsed, the mixture was transferred to a PTFE dish with a diameter of 5 cm, and the solvent was dried at room temperature for 4 days to produce a film.

The polycarbonate resin composition thus produced was evaluated for self-healing property, mechanical properties, and solvent resistance, and measured for thickness. The viscosity average molecular weight, glass transition temperature, and endothermic onset and end temperatures were also measured. The results are shown in Table 1.

Note that a component derived from a conjugated diene structure in Table 1 refers to a carbonate structural unit derived from a compound having a conjugated diene skeleton before the Diels-Alder reaction, and the content thereof represents the content ratio of the carbonate structural unit derived from a compound having a conjugated diene skeleton before the Diels-Alder reaction based on 100 mass % of the polycarbonate resin composition of the present invention. A component derived from the compound having a dienophile group refers to a compound having a dienophile group added before the Diels-Alder reaction, and the content thereof represents the content ratio of the compound having a dienophile group added based on 100 mass % of the polycarbonate resin composition of the present invention.

### Example 2

Polymerization was performed by the method described in Example 1, except that a raw material mixture was prepared by adding 12.91 g (about 0.0400 mol) of Bis26X-FF, 42.65 g (about 0.187 mol) of BPA, 44.44 g (about 0.0400 mol) of PO3G1000, 58.89 g (about 0.275 mol) of DPC, and a 4.0 mass % aqueous solution of cesium carbonate as a catalyst in such a manner that the concentration of cesium carbonate was 120 μmol per mol of the all the dihydroxy compound, thereby preparing the raw material mixture.

3 g of the produced polycarbonate resin and 0.249 g of bismaleimide were mixed and dried by the method described in Example 1 to produce a film.

The polycarbonate resin composition thus produced was evaluated for self-healing property, mechanical properties, and solvent resistance, and measured for thickness. The viscosity average molecular weight, glass transition temperature, and endothermic onset and end temperatures were also measured. The results are shown in Table 1.

### Example 3

Polymerization was performed by the method described in Example 1 except that 14.44 g (about 0.0448 mol) of Bis26X-FF, 36.80 g (about 0.161 mol) of BPA, 48.77 g (about 0.0179 mol) of PO3G2700, and 49.40 g (about 0.231 mol) of DPC were used as raw materials.

3 g of the produced polycarbonate resin, 0.281 g of bismaleimide, and 30 mL of methylene chloride were used to perform mixing and drying by the method described in Example 1 to produce a film.

The polycarbonate resin composition thus produced was evaluated for self-healing property, mechanical properties, and solvent resistance, and measured for thickness. The viscosity average molecular weight, glass transition temperature, and endothermic onset and end temperatures were also measured. The results are shown in Table 1.

### Example 4

Polymerization was performed by the method described in Example 1 except that 4.06 g (about 0.0126 mol) of Bis26X-FF, 10.35 g (about 0.0453 mol) of BPA, 5.59 g (about 0.0050 mol) of PO3G1000, and 14.03 g (about 0.0655 mol) of DPC were used as raw materials.

3 g of the produced polycarbonate resin, 0.386 g of bismaleimide, and 30 mL of methylene chloride were used to perform mixing and drying by the method described in Example 1 to produce a film.

The polycarbonate resin composition thus produced was evaluated for self-healing property, mechanical properties, and solvent resistance, and measured for thickness. The viscosity average molecular weight, glass transition temperature, and endothermic onset and end temperatures were also measured. The results are shown in Table 1.

### Comparative Example 1

3 g of the polycarbonate resin polymerized in Example 1 and 15 mL of methylene chloride were used to perform mixing and drying by the method described in Example 1 without adding bismaleimide to produce a film.

The polycarbonate resin composition thus produced was evaluated for self-healing property, mechanical properties, and solvent resistance, and measured for thickness. The viscosity average molecular weight, glass transition temperature, and endothermic onset and end temperatures were also measured. The results are shown in Table 1.

### Comparative Example 2

Polymerization was performed in the method described in Example 1 except that 22.14 g (about 0.0687 mol) of Bis26X-FF, 58.80 g (about 0.258 mol) of BPA, 19.06 g (about 0.0172 mol) of PO3G1000, and 76.51 g (about 0.357 mol) of DPC were used as raw materials.

3 g of the produced polycarbonate resin, 0.419 g of bismaleimide, and 30 mL of methylene chloride were used to perform mixing and drying by the method described in Example 1 to produce a film.

The polycarbonate resin composition thus produced was evaluated for self-healing property, mechanical properties, and solvent resistance, and measured for thickness. The viscosity average molecular weight, glass transition temperature, and endothermic onset and end temperatures were also measured. The results are shown in Table 1.

### Comparative Example 3

Polymerization was performed by the method described in Example 1 except that 13.56 g (about 0.0421 mol) of Bis26X-FF, 86.44 g (about 0.379 mol) of BPA, and 92.83 g (about 0.433 mol) of DPC were used as raw materials.

3 g of the produced polycarbonate resin, 0.252 g of bismaleimide, and 30 mL of methylene chloride were used to perform mixing and drying by the method described in Example 1 to produce a film.

The polycarbonate resin composition thus produced was evaluated for self-healing property, mechanical properties, and solvent resistance, and measured for thickness. The viscosity average molecular weight, glass transition temperature, and endothermic onset and end temperatures were also measured. The results are shown in Table 1.

### Comparative Example 4

Polymerization was performed by the method described in Example 1 except that 7.30 g (about 0.0301 mol) of BisB, 10.15 g (about 0.0502 mol) of DHDE, 7.56 g (about 0.0201 mol) of BIP-ANT, 22.15 g (about 0.103 mol) of DPC, and a 0.4 mass % aqueous solution of cesium carbonate as a catalyst were added in such a manner that the concentration of cesium carbonate was 15 μmol per mol of all the dihydroxy compound, thereby preparing a raw material mixture, and the temperature was raised from 220° C. to 285° C., instead of to 260° C., during polymerization.

3 g of the produced polycarbonate resin, 0.483 g of bismaleimide, and 30 mL of methylene chloride were used to perform mixing and drying by the method described in Example 1 to produce a film.

The polycarbonate resin composition thus produced was evaluated for self-healing property, mechanical properties, and solvent resistance, and measured for thickness. The viscosity average molecular weight, glass transition temperature, and endothermic onset and end temperatures were also measured. The results are shown in Table 1.

Note that the “maleimide/furan molar ratio” in Table 1 is the “molar ratio of compound (II)/polycarbonate resin composition (I)”.

TABLE 1

| | | | | Example | | | |
|---|---|---|---|---|---|---|---|
| | | | | 1 | 2 | 3 | 4 |
| Content of | Carbonate structural | Bis26X-FF | | 14.1 | 12.0 | 13.5 | 18 |
| each | unit (A) | BIP-ANT | | 0 | 0 | 0 | 0 |
| component in | Carbonate structural | PO3G1000 | | 46.0 | 39.3 | 0 | 23.4 |
| polycarbonate | unit (B) | PO3G2700 | | 0 | 0 | 42.5 | 0 |
| resin | Other carbonate | BPA | | 30.9 | 41.0 | 35.4 | 47.2 |
| composition | structural units | BisB | | 0 | 0 | 0 | 0 |
| [mass %] | | DHDE | | 0 | 0 | 0 | 0 |
| | Compound (II) | Bis(3-ethyl-5-methyl-4-maleimidophenyl)methane | | 9.0 | 7.7 | 8.6 | 11.4 |
| | Total | | | 100 | 100 | 100 | 100 |
| Bismaleimide addition amount | | Maleimide/furan molar ratio | | 1 | 1 | 1 | 1 |
| Polycarbonate resin composition (I) | | Viscosity average molecular weight Mv | | 17460 | 18820 | 30560 | 24220 |
| DSC measurement | | Glass transition temperature Tg (° C.) | | −46 | −53 | −60 | 36 |
| | | Endothermic onset temperature/endothermic | | 91/135 | 106/127 | 91/135 | 87/168 |
| | | end temperature (° C.) | | | | | |
| Evaluation | Self-healing property | Recovery of scratch (load | 30° C. 6 h | ∘ | ∘ | ∘ | x |
| results | | 750 g, pencil hardness 4H) | 70° C. 6 h | ∘ | ∘ | ∘ | ∘ to Δ |
| | Mechanical strength | Film folding test | | ∘ | ∘ | ∘ | ∘ |
| | Solvent resistance | Methylene chloride, 23° C. 7 h | | ∘ | Δ | ∘ | ∘ |
| | — | Thickness (mm) | | 0.69 | 0.87 | 0.76 | 0.75 |
| | | | | Comparative Example | | | |
| | | | | 1 | 2 | 3 | 4 |
| Content of | Carbonate structural | Bis26X-FF | | 15.5 | 19.3 | 12.2 | 0 |
| each | unit (A) | BIP-ANT | | 0 | 0 | 0 | 25.2 |
| component in | Carbonate structural | PO3G1000 | | 50.6 | 15.7 | 0 | 0 |
| polycarbonate | unit (B) | PO3G2700 | | 0 | 0 | 0 | 0 |
| resin | Other carbonate | BPA | | 33.9 | 52.8 | 80.1 | 0 |
| composition | structural units | BisB | | 0 | 0 | 0 | 25.2 |
| [mass %] | | DHDE | | 0 | 0 | 0 | 35.7 |
| | Compound (II) | Bis(3-ethyl-5-methyl-4-maleimidophenyl)methane | | 0 | 12.2 | 7.7 | 13.9 |
| | Total | | | 100 | 100 | 100 | 100 |
| Bismaleimide addition amount | | Maleimide/furan molar ratio | | 0 | 1 | 1 | 1 |
| Polycarbonate resin composition (I) | | Viscosity average molecular weight Mv | | 17460 | 23100 | 13840 | 15940 |
| DSC measurement | | Glass transition temperature Tg (° C.) | | −46 | 54 | 70 | 63 |
| | | Endothermic onset temperature/endothermic | | n.d. | 96/188 | 122/156 | 119/211 |
| | | end temperature (° C.) | | | | | |
| Evaluation | Self-healing property | Recovery of scratch (load | 30° C. 6 h | x | x | x | x |
| results | | 750 g, pencil hardness 4H) | 70° C. 6 h | x | x | x | x |

| | | | | | |
|---|---|---|---|---|---|
| Mechanical strength | Film folding test | ∘ | x | x | x |
| Solvent resistance | Methylene chloride, 23° C. 7 h | x | ∘ | x | x |
| — | Thickness (mm) | 1.00 | 0.76 | 0.52 | 0.51 |

### Discussion

The following can be seen from the above results.

The polycarbonate resin compositions of Examples 1 to 4 have a glass transition temperature of 50° C. or lower. The DSC measurement found an endothermic peak suggesting that the dissociation of a bond between polymer chains by the Diels-Alder reaction was present, and thus it is presumed that the bond between the polymer chains by the Diels-Alder reaction was present. It is likely that the polycarbonate resin compositions had the glass transition temperature of 50° C. or lower and a bond between polymer chains by the Diels-Alder reaction, and thus, had a favorable self-healing property, mechanical strength, and solvent resistance.

In Comparative Example 1, bismaleimide was not added, and thus, there was no bond between polymer chains by the Diels-Alder reaction. Accordingly, the film was broken in the pencil test, and could not be repaired. In addition, the solvent resistance was low.

In Comparative Examples 2 to 4, the DSC measurement found an endothermic peak suggesting the dissociation of the bond between polymer chains by the Diels-Alder reaction, it is presumed that the bond between the polymer chains by the Diels-Alder reaction was present. However, the glass transition temperature was not present at 50° C. or lower, revealing that the self-healing property and the mechanical strength were poor.

The above results show that the polycarbonate resin composition of the present invention is excellent in self-healing property, mechanical strength, and solvent resistance.

The present invention has been described in detail with reference to specific aspects, however, it will be apparent to those skilled in the art that various modifications can be made within the scope where the effects of the present invention are exhibited.

The present application is based on Japanese Patent Application No. 2023-054760 filed on Mar. 30, 2023, which is incorporated by citation in its entirety.

### INDUSTRIAL APPLICABILITY

The polycarbonate resin composition of the present invention can be widely used as a material for producing parts in the fields of automobiles, electrical and electronic materials, and other industries.

1. A polycarbonate resin composition, having:
at least one glass transition temperature of 50° C. or lower; and
a bond between polymer chains by a Diels-Alder reaction.

2. The polycarbonate resin composition according to claim 1, having at least one glass transition temperature of lower than 25° C.

3. The polycarbonate resin composition according to claim 1, wherein the bond between the polymer chains of the polycarbonate resin composition is formed by a reaction between a polycarbonate resin composition (I) having two or more conjugated diene structures and a compound (II) having two or more dienophile groups.

4. The polycarbonate resin composition according to claim 1, wherein the bond between the polymer chains of the polycarbonate resin composition is formed by a reaction between a polycarbonate resin composition (III) having two or more dienophile structures and a compound (IV) having two or more conjugated diene groups.

5. The polycarbonate resin composition according to claim 1, wherein the bond between the polymer chains of the polycarbonate resin composition is formed by a reaction between the polycarbonate resin composition (I) having two or more conjugated diene structures and the polycarbonate resin composition (III) having two or more dienophile structures.

6. The polycarbonate resin composition according to claim 3, wherein the polycarbonate resin composition (I) having two or more conjugated diene structures has a conjugated diene structure represented by any one of the group consisting of Formulae (2), (3) and (4): 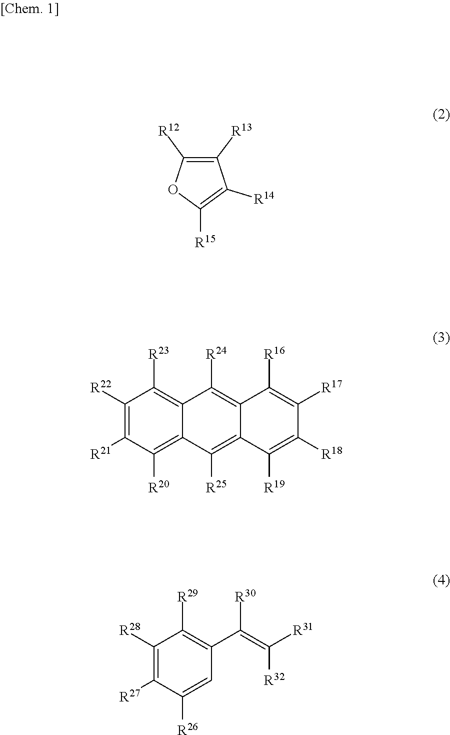
where
in Formula (2),
R¹² to R¹⁵ each independently represent a single bond, a bonding group to another skeleton, a hydrogen atom, an aliphatic hydrocarbon group having 1 to 12 carbon atoms, an aromatic hydrocarbon group having 6 to 12 carbon atoms, or an alkoxy group having 1 to 10 carbon atoms, and
one or two of R¹² to R¹⁵ are a single bond or a bonding group to another skeleton;
in Formula (3),
R¹⁶ to R²⁵ each independently represent a single bond, a bonding group to another skeleton, a hydrogen atom, an aliphatic hydrocarbon group having 1 to 12 carbon atoms, an aromatic hydrocarbon group having 6 to 12 carbon atoms, or an alkoxy group having 1 to 10 carbon atoms, and
one or two of R¹⁶ to R²⁵ are a single bond or a bonding group to another skeleton; and
in Formula (4),
R²⁶ to R³² each independently represent a single bond, a bonding group to another skeleton, a hydrogen atom, an aliphatic hydrocarbon group having 1 to 12 carbon atoms, an aromatic hydrocarbon group having 6 to 12 carbon atoms, or an alkoxy group having 1 to 10 carbon atoms, and
one or two of R²⁶ to R³² are a single bond or a bonding group to another skeleton.

7. The polycarbonate resin composition according to claim 3, wherein the polycarbonate resin composition (I) having two or more conjugated diene structures contains a carbonate structural unit (A) derived from a dihydroxy compound having a conjugated diene structure represented by Formula (A-1): 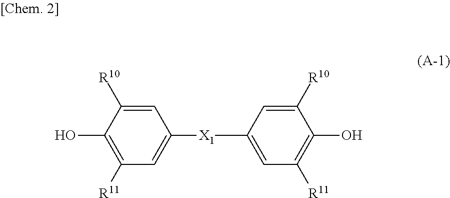
where
R¹⁰ and R¹¹ each independently represent a hydrogen atom, an alkyl group, or an aryl group, and
X¹ represents a divalent linking group containing a conjugated diene structure.

8. The polycarbonate resin composition according to claim 7, wherein the dihydroxy compound having a conjugated diene structure represented by Formula (A-1) contains at least one dihydroxy compound represented by any one of the group consisting of Formulae (A-2), (A-3), and (A-4): 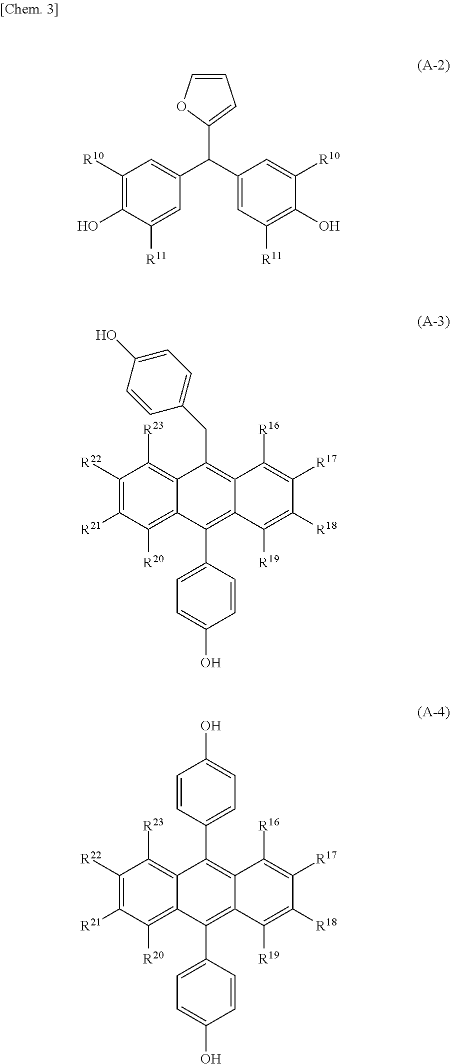
where
in Formula (A-2),
R¹⁰ and R¹¹ each independently represent a hydrogen atom, an alkyl group, or an aryl group; and
in Formulae (A-3) and (A-4),
R¹⁶ to R²³ each independently represent a hydrogen atom, an aliphatic hydrocarbon group having 1 to 12 carbon atoms, an aromatic hydrocarbon group having 6 to 12 carbon atoms, or an alkoxy group having 1 to 10 carbon atoms.

9. The polycarbonate resin composition according to claim 8, wherein the dihydroxy compounds represented by Formulae (A-2), (A-3), and (A-4) are dihydroxy compounds represented by Formulae (A-5), (A-6), and (A-7), respectively.

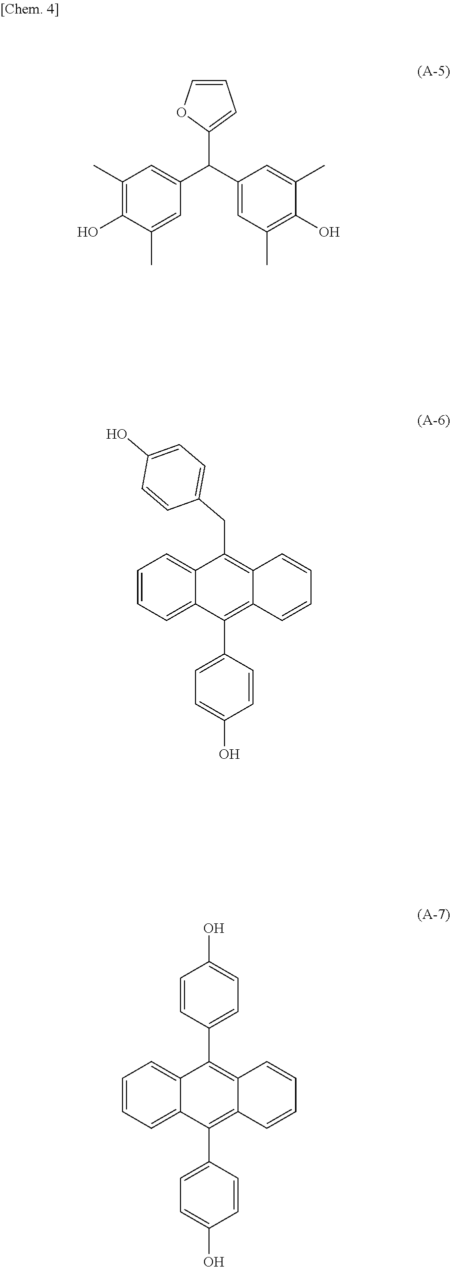 [SMILES: Cc1cc(C(c2cc(C)c(O)c(C)c2)c2ccco2)cc(C)c1O ; Oc1ccc(Cc2c3ccccc3c(-c3ccc(O)cc3)c3ccccc23)cc1 ; Oc1ccc(-c2c3ccccc3c(-c3ccc(O)cc3)c3ccccc23)cc1]

10. The polycarbonate resin composition according to claim 4, wherein the compound (IV) having two or more conjugated diene groups has a structure represented by any one of the group consisting of Formulae (2), (3), and (4): 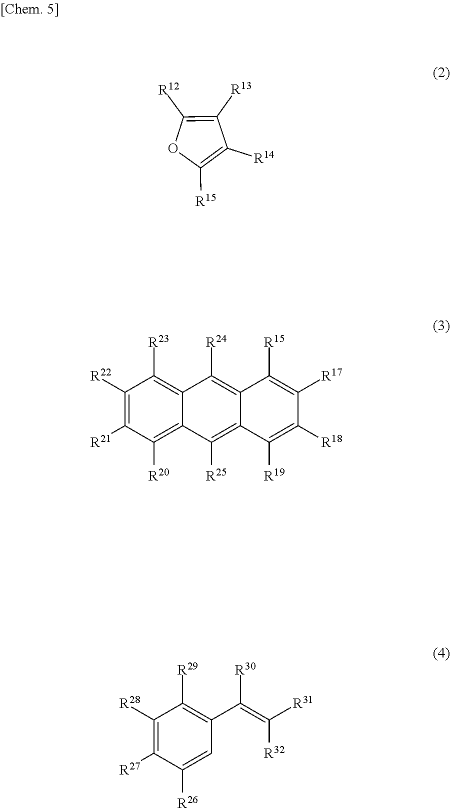
where
in Formula (2),
R¹² to R¹⁵ each independently represent a single bond, a bonding group to another skeleton, a hydrogen atom, an aliphatic hydrocarbon group having 1 to 12 carbon atoms, an aromatic hydrocarbon group having 6 to 12 carbon atoms, or an alkoxy group having 1 to 10 carbon atoms, and
one or two of R¹² to R¹⁵ are a single bond or a bonding group to another skeleton;
in Formula (3),
R¹⁶ to R²⁵ each independently represent a single bond, a bonding group to another skeleton, a hydrogen atom, an aliphatic hydrocarbon group having 1 to 12 carbon atoms, an aromatic hydrocarbon group having 6 to 12 carbon atoms, or an alkoxy group having 1 to 10 carbon atoms, and
one or two of R¹⁶ to R²⁵ are a single bond or a bonding group to another skeleton; and
in Formula (4),
R²⁶ to R³² each independently represent a single bond, a bonding group to another skeleton, a hydrogen atom, an aliphatic hydrocarbon group having 1 to 12 carbon atoms, an aromatic hydrocarbon group having 6 to 12 carbon atoms, or an alkoxy group having 1 to 10 carbon atoms, and
one or two of R²⁶ to R³² are a single bond or a bonding group to another skeleton.

11. The polycarbonate resin composition according to claim 3, wherein the polycarbonate resin composition (I) has a viscosity average molecular weight of 10000 to 50000.

12. The polycarbonate resin composition according to claim 3, wherein the compound (II) having two or more dienophile groups has a dienophile group having a structure represented by Formula (5).

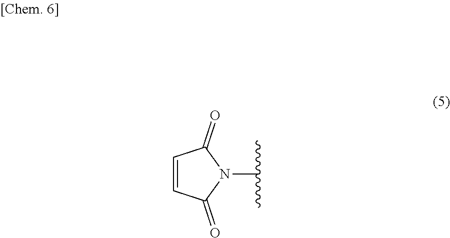 [SMILES: *N1C(=O)C=CC1=O]

13. The polycarbonate resin composition according to claim 12, wherein the compound (II) having two or more dienophile groups is a compound represented by Formula (II-1): 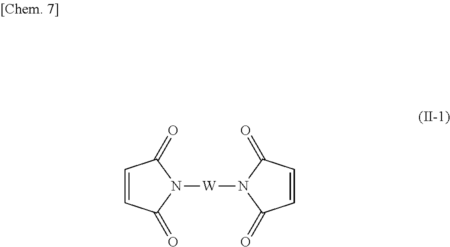
where
W represents a single bond or a divalent linking group consisting of 1 to 30 carbon atoms, 0 to 2 oxygen atoms, and a hydrogen atom.

14. The polycarbonate resin composition according to claim 4, wherein the polycarbonate resin composition (III) having two or more dienophile structures has a dienophile structure represented by Formula (5).

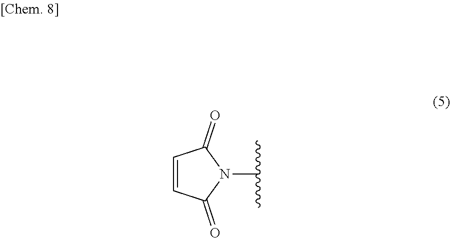 [SMILES: *N1C(=O)C=CC1=O]

15. The polycarbonate resin composition according to claim 1, comprising a carbonate structural unit (B) derived from an aliphatic dihydroxy compound represented by Formula (B-1): 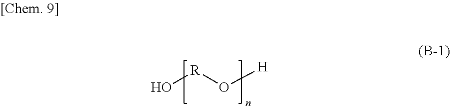
where
R represents an alkylene group having 1 to 20 carbon atoms, and n is an integer of 1 to 100.

16. The polycarbonate resin composition according to claim 15, wherein a content of the carbonate structural unit (B) per 100 mass % of the polycarbonate resin composition is 20 mass % or more and 99 mass % or less.

17. The polycarbonate resin composition according to claim 15, wherein an aliphatic dihydroxy compound represented by Formula (B-1) is an aliphatic dihydroxy compound represented by Formula (B-2): 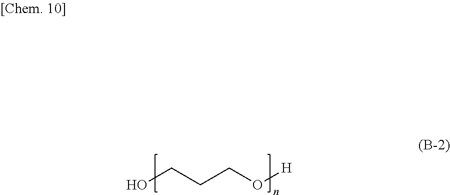
where
n is an integer of 1 to 100.

18. The polycarbonate resin composition according to claim 17, wherein the aliphatic dihydroxy compound represented by Formula (B-2) has a number average molecular weight of 200 or more and 3000 or less.

19. The polycarbonate resin composition according to claim 1, comprising a carbonate structural unit (C) derived from an aromatic dihydroxy compound represented by Formula (C-1): 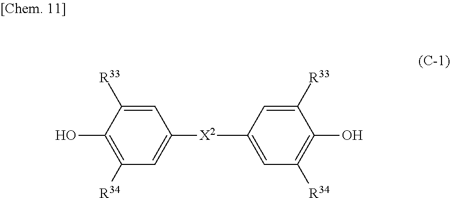
where
R³³ and R³⁴ each independently represent a hydrogen atom, an alkyl group, or an aryl group,
X² represents —O—, —S—, —SO₂—, or —CR³⁵R³⁶—,
with the proviso that R³⁵ and R³⁶ each independently represent a hydrogen atom, a substituted or unsubstituted alkyl group having 1 to 20 carbon atoms, or a substituted or unsubstituted aryl group, and the alkyl groups of R³⁵ and R³⁶ is optionally bonded to each other to form a ring, and
X² contains no conjugated diene structure.

20. The polycarbonate resin composition according to claim 5, wherein the polycarbonate resin composition (I) having two or more conjugated diene structures has a conjugated diene structure represented by any one of the group consisting of Formulae (2), (3) and (4): 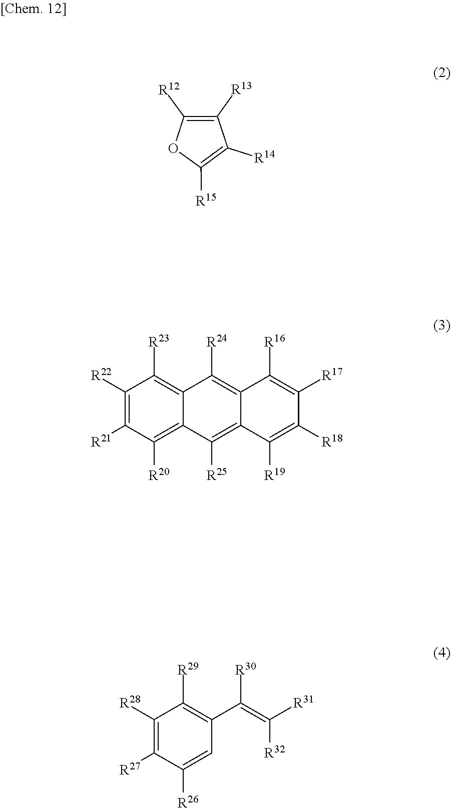
where
in Formula (2),
R¹² to R¹⁵ each independently represent a single bond, a bonding group to another skeleton, a hydrogen atom, an aliphatic hydrocarbon group having 1 to 12 carbon atoms, an aromatic hydrocarbon group having 6 to 12 carbon atoms, or an alkoxy group having 1 to 10 carbon atoms, and
one or two of R¹² to R¹⁵ are a single bond or a bonding group to another skeleton;
in Formula (3),
R¹⁶ to R²⁵ each independently represent a single bond, a bonding group to another skeleton, a hydrogen atom, an aliphatic hydrocarbon group having 1 to 12 carbon atoms, an aromatic hydrocarbon group having 6 to 12 carbon atoms, or an alkoxy group having 1 to 10 carbon atoms, and
one or two of R¹⁶ to R²⁵ are a single bond or a bonding group to another skeleton; and
in Formula (4),
R²⁶ to R³² each independently represent a single bond, a bonding group to another skeleton, a hydrogen atom, an aliphatic hydrocarbon group having 1 to 12 carbon atoms, an aromatic hydrocarbon group having 6 to 12 carbon atoms, or an alkoxy group having 1 to 10 carbon atoms, and
one or two of R²⁶ to R³² are a single bond or a bonding group to another skeleton.

21. The polycarbonate resin composition according to claim 5, wherein the polycarbonate resin composition (I) having two or more conjugated diene structures contains a carbonate structural unit (A) derived from a dihydroxy compound having a conjugated diene structure represented by Formula (A-1): 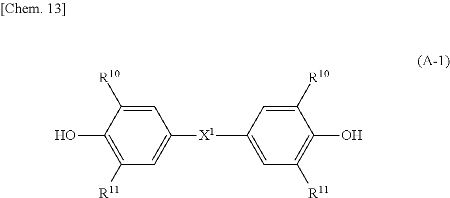
where
R¹⁰ and R¹¹ each independently represent a hydrogen atom, an alkyl group, or an aryl group, and
X¹ represents a divalent linking group containing a conjugated diene structure.

22. The polycarbonate resin composition according to claim 21, wherein the dihydroxy compound having a conjugated diene structure represented by Formula (A-1) contains at least one dihydroxy compound represented by any one of the group consisting of Formulae (A-2), (A-3), and (A-4): 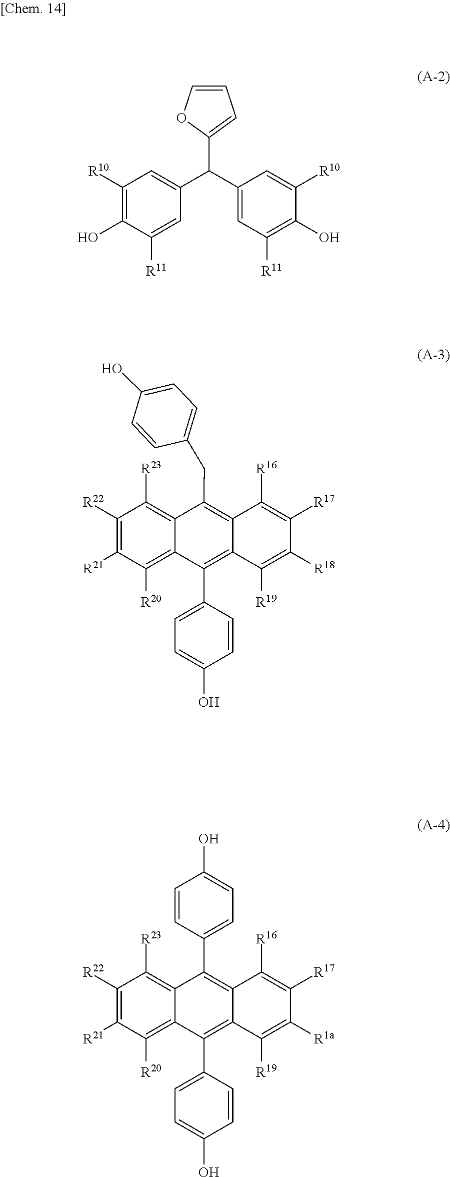
where
in Formula (A-2),
R¹⁰ and R¹¹ each independently represent a hydrogen atom, an alkyl group, or an aryl group; and
in Formulae (A-3) and (A-4),
R¹⁶ to R²³ each independently represent a hydrogen atom, an aliphatic hydrocarbon group having 1 to 12 carbon atoms, an aromatic hydrocarbon group having 6 to 12 carbon atoms, or an alkoxy group having 1 to 10 carbon atoms.

23. The polycarbonate resin composition according to claim 22, wherein the dihydroxy compounds represented by Formulae (A-2), (A-3), and (A-4) are dihydroxy compounds represented by Formulae (A-5), (A-6), and (A-7), respectively.

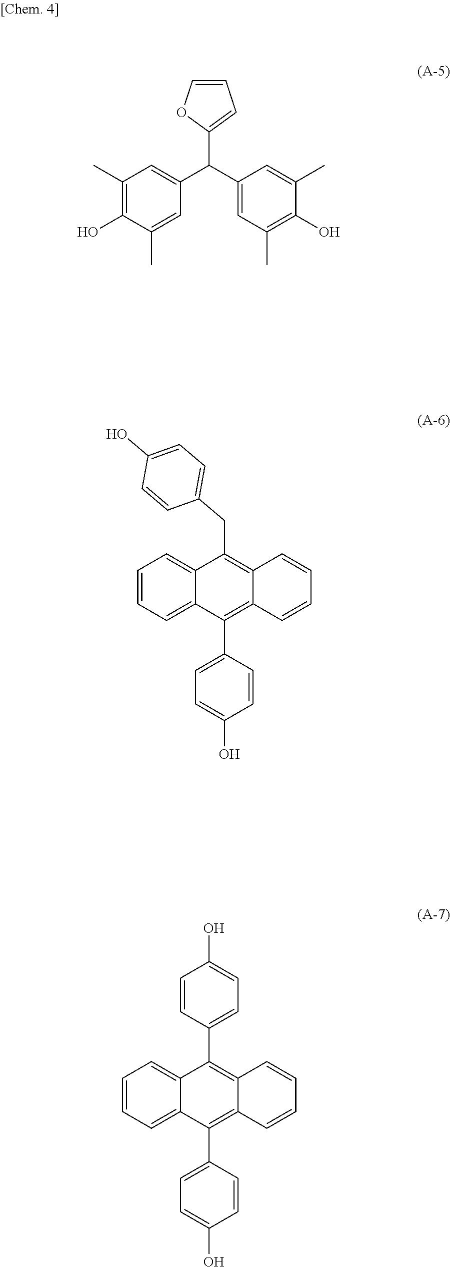 [SMILES: Cc1cc(C(c2cc(C)c(O)c(C)c2)c2ccco2)cc(C)c1O ; Oc1ccc(Cc2c3ccccc3c(-c3ccc(O)cc3)c3ccccc23)cc1 ; Oc1ccc(-c2c3ccccc3c(-c3ccc(O)cc3)c3ccccc23)cc1]

24. The polycarbonate resin composition according to claim 5, wherein the polycarbonate resin composition (I) has a viscosity average molecular weight of 10000 to 50000.

25. The polycarbonate resin composition according to claim 5, wherein the polycarbonate resin composition (III) having two or more dienophile structures has a dienophile structure represented by Formula (5). 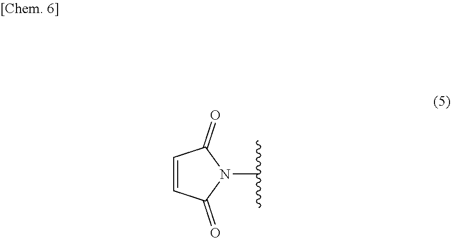 [SMILES: *N1C(=O)C=CC1=O]
